(19) United States
(12) Patent Application Publication
(10) Pub. No.: US 2026/0289522 A1
(43) Pub. Date: Sep. 24, 2026

(54) SYSTEM AND METHOD OF REAL-TIME NODE GRAPH SYNCHRONIZATION USING LARGE LANGUAGE MODELS AND RETRIEVAL-AUGMENTED GENERATION

(71) Applicant: Kaizen Pro, Inc., San Francisco, CA (US)

(72) Inventors: Eric Carlson, San Francisco, CA (US); Pamela Carlson, San Francisco, CA (US)

(73) Assignee: Kaizen Pro, Inc., San Francisco, CA (US)

(21) Appl. No.: 19/083,905

(22) Filed: Mar. 19, 2025

(51) Int. Cl. G06Q 10/20; G06F 16/27

(52) U.S. Cl. CPC G06Q 10/20; G06F 16/27

(57) ABSTRACT

A system of real-time synchronization of a nodal network data structure including one or more processors to receive initial vehicle damage data of a vehicle; execute a large language model using the initial vehicle damage data to retrieve first one or more repair records from a retrieval-augmented generation database; generate a nodal network data structure based on the retrieved one or more repair records and the damage location; generate a first visual representation of the nodal network data structure for presentation on a user interface at the client device; receive additional vehicle damage data; execute the large language model using the additional vehicle damage data to retrieve second one or more repair records; generate a second operation node and an edge; and generate, using the large language model, a second visual representation of the nodal network data structure for presentation on a user interface at the client device.

### BACKGROUND

Vehicle repair systems can rely on static databases to retrieve the relevant information for repairing vehicles. While such repair databases may contain historical repair data, current systems lack efficient mechanisms for semantic matching between current damage scenarios and historical repair records. Keyword-based search methods fail to capture the complex relationships between vehicle components, repair procedures, and equipment requirements, resulting in slow information retrieval during the vehicle repair process.

### SUMMARY

Graph data structures can face technical limitations in maintaining synchronized digital twins of physical vehicle repair processes, particularly because it can be difficult to dynamically modify the graphs to reflect real-time changes the necessary repair process as new vehicle damage is discovered. A data processing system can overcome these technical challenges relating to real-time synchronization between a physical vehicle repair process and its graph representation. To do so, the data processing system can process vehicle damage data using a large language model to generate an initial nodal network data structure that includes operation and equipment nodes that reflect a current vehicle repair process for the vehicle. The data processing system can then dynamically modify the nodal network data structure by automatically generating new nodes and edges as additional damage is discovered on the vehicle during the repair process. The data processing system can perform this real-time nodal network generation and modification using multiple agents that operate as a cohort for retrieval-augmented generation (RAG) for node content generation and an edge creation protocol that maintains consistency between the repair plan and its digital representation. The data processing system can preserve graph integrity during data structure updates by validating edge connections through a multi-agent consensus process, which can cause the data structure to accurately reflect updates appropriate for the repair plan to mitigate or resolve uncovered damages while maintaining referential integrity across the entire nodal network data structure.

At least one aspect of a technical solution is directed to a system of real-time synchronization of a nodal network data structure. The system can include one or more processors. The one or more processors can receive, from a client device, initial vehicle damage data comprising at least damage location information and vehicle identification information of a vehicle. The one or more processors can execute a large language model using the initial vehicle damage data and the vehicle identification information to retrieve first one or more repair records from a retrieval-augmented generation (RAG) database. The one or more processors can generate a nodal network data structure based on the retrieved one or more repair records and the damage location information such that the nodal network data structure comprises a plurality of linked operation nodes and one or more equipment nodes linked to each of the operation nodes. The one or more processors can generate, using the large language model, a first visual representation of the nodal network data structure for presentation on a user interface at the client device. The one or more processors can receive additional vehicle damage data corresponding to a first operation node of the linked operation nodes. The one or more processors can execute the large language model using the additional vehicle damage data and the vehicle identification information of the vehicle to retrieve second one or more repair records from the RAG database. The one or more processors can generate a second operation node and an edge between the first operation node and the second operation node based on the second one or more repair records. The one or more processors can generate, using the large language model, a second visual representation of the nodal network data structure for presentation on a user interface at the client device.

At least one aspect of a technical solution is directed to a method of real-time synchronization of a nodal network data structure. The method can include receiving, by one or more processors from a client device, initial vehicle damage data comprising at least damage location information and vehicle identification information of a vehicle. The method can include executing, by the one or more processors, a large language model using the initial vehicle damage data and the vehicle identification information to retrieve first one or more repair records from a retrieval-augmented generation (RAG) database. The method can include generating, by the one or more processors, a nodal network data structure based on the retrieved one or more repair records and the damage location information such that the nodal network data structure comprises a plurality of linked operation nodes and one or more equipment nodes linked to each of the operation nodes. The method can include generating, by the one or more processors using the large language model, a first visual representation of the nodal network data structure for presentation on a user interface at the client device. The method can include receiving, by the one or more processors, additional vehicle damage data corresponding to a first operation node of the linked operation nodes. The method can include executing, by the one or more processors, the large language model using the additional vehicle damage data and the vehicle identification information of the vehicle to retrieve second one or more repair records from the RAG database. The method can include generating, by the one or more processors, a second operation node and an edge between the first operation node and the second operation node based on the second one or more repair records. The method can include generating, by the one or more processors using the large language model, a second visual representation of the nodal network data structure for presentation on a user interface at the client device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system of synchronizing a nodal network data structure, in accordance with implementations.

FIG. 2 is an illustration of an example method of synchronizing a nodal network data structure, in accordance with implementations.

FIG. 3 is an illustration of a nodal network data structure, in accordance with implementations.

FIG. 4 is an illustration of a graphical user interface for inputting vehicle damage information, in accordance with implementations.

FIG. 5 is an illustration of a graphical user interface for inputting vehicle damage information, in accordance with implementations.

FIG. 6 is an illustration of a graphical user interface presenting a visual representation of a nodal network data structure, in accordance with implementations.

FIG. 7 is an illustration of a graphical user interface presenting a visual representation of a nodal network data structure, in accordance with implementations.

FIG. 8 is an illustration of an example sequence of a multi-agent system for updating a nodal network data structure, in accordance with implementations.

FIG. 9 is an illustration of an example sequence of resolving a conflict in updating a nodal network data structure, in accordance with implementations.

FIG. 10 is a block diagram illustrating an architecture of a computer system that can be employed to implement elements of the systems and methods described and illustrated herein, including, for example, the system depicted in FIG. 1 and the method depicted in FIG. 1.

FIGS. 11A-11D illustrate a sequence of updating a nodal network data structure, in accordance with implementations.

### DETAILED DESCRIPTION

Following below are more detailed descriptions of various concepts related to, and implementations of, methods, apparatuses, and systems of real-time synchronization of a nodal network data structure. The various concepts introduced above and discussed in greater detail below may be implemented in any of numerous ways.

Vehicle repair systems can rely on static repair databases to accurately identify and sequence repair operations. Inaccuracies in repair planning and sequencing can lead to inefficient repairs, missed damage, and incorrect cost estimates. This can affect repair quality, cycle time, and a repair facility's ability to effectively manage operations and resources.

A technical issue with repair planning systems can include their reliance on pre-defined repair procedures that cannot dynamically adapt to newly discovered damage during the repair process. A recurring issue is that additional damage found during disassembly or repair can require replanning and can disrupt the entire repair sequence, leading to delays and inefficiencies.

A data processing system implementing the systems and methods described herein can dynamically generate and update repair sequences as new damage is discovered when repairing a vehicle. The data processing system can generate (e.g., automatically generate) updated repair plans that maintain proper repair sequences and dependencies. To do so, the data processing system can use a large language model to process repair records from a retrieval-augmented generation (RAG) database containing repair procedures, technical specifications, and historical repair data. The data processing system can generate a nodal network data structure that represents a complete repair plan with linked operation and equipment nodes from the retrieved data. For example, the data processing system can use the large language model to process initial vehicle damage data of the damaged vehicle and retrieve relevant repair procedures or other types of relevant records from the RAG database. The data processing system can generate a nodal network data structure that includes operation nodes that represent repair steps and equipment nodes that represent required tools and parts for performing the respective operations. The nodes can be connected by edges that maintain repair sequences and dependencies. When additional damage is discovered, the system can process this new information through the large language model to retrieve additional repair procedures and dynamically update the nodal network data structure with new operation and equipment nodes while maintaining the dependencies (e.g., edges) between nodes.

The data processing system can generate visual representations of the repair plan. The visual representations can include text descriptions, videos, images, comic sequences, etc., outlining a sequence of operations for repairing the vehicle and data about those operations. The data processing system can generate the visual representations of the repair plan from the nodal network data structure using the large language model. A technician performing the repair process can follow the instructions outlined in the visual representations of the repair plan.

The data processing system can dynamically update the nodal network data structure to reflect newly discovered damage to the vehicle. For example, as the technician is repairing the vehicle, the technician may identify new areas of damage in the vehicle. The technician can provide an input describing or identifying the new areas of damage. The data processing system can receive the input and update the nodal network data structure to include nodes that represent operations for repairing the new damage.

By implementing the systems and methods described herein with the large language model and RAG database, the data processing system can generate and update repair plans with less latency, more accuracy, and using less processing power than other methods. The data processing system can do so by avoiding the limitations of static repair databases and pre-defined repair sequences that cannot adapt to newly discovered damage. The data processing system can additionally maintain proper repair sequences and dependencies when updating repair plans without requiring replanning. Accordingly, the data processing system can operate to automatically generate and update accurate repair plans using fewer computing resources and more quickly than other systems.

Another technical problem that the solution described herein solves relates to large language models. For example, large language models often struggle with generating accurate and consistent repair plans when processing raw repair documentation directly. When such models process a large amount of repair documentation, they tend to hallucinate steps or requirements that don't exist in the source material, particularly by generating instructions based on the middle portions of large text inputs. Additionally, providing large language models with both original documentation and new damage information as raw text increases the likelihood of hallucinated connections between repair steps and can incur substantial computational resources to repeat the update or to recreate the nodal network data structure.

The technical solution described herein addresses these challenges by introducing an intermediate nodal network data structure that serves as a structured representation of a repair plan for repairing a vehicle. Instead of the large language model processing raw repair documentation each time a repair plan needs to be generated or updated, the data processing system can first identify relevant documentation for the plan and then convert the identified repair information into a graph-based data structure with explicit nodes for operations and equipment, connected by edges that represent dependencies and sequences. This structure provide the large language model with a precise, minimal input format that reduces the amount of text the model processes to generate the repair plan.

By implementing this technical solution, the system can generate more accurate repair plans with fewer hallucinations compared to systems that rely on direct processing of repair documentation by large language models. When updates are needed due to newly discovered damage, the data processing system can modify the nodal network data structure directly by adding or modifying specific nodes and edges, requiring the large language model to only process these targeted changes rather than reprocessing the entire repair context. The structured nature of the nodal network data structure can ensure that the large language model's outputs remain based on valid repair relationships while supporting dynamic updates as repair requirements change, resulting in a more reliable and responsive system for managing complex vehicle repairs.

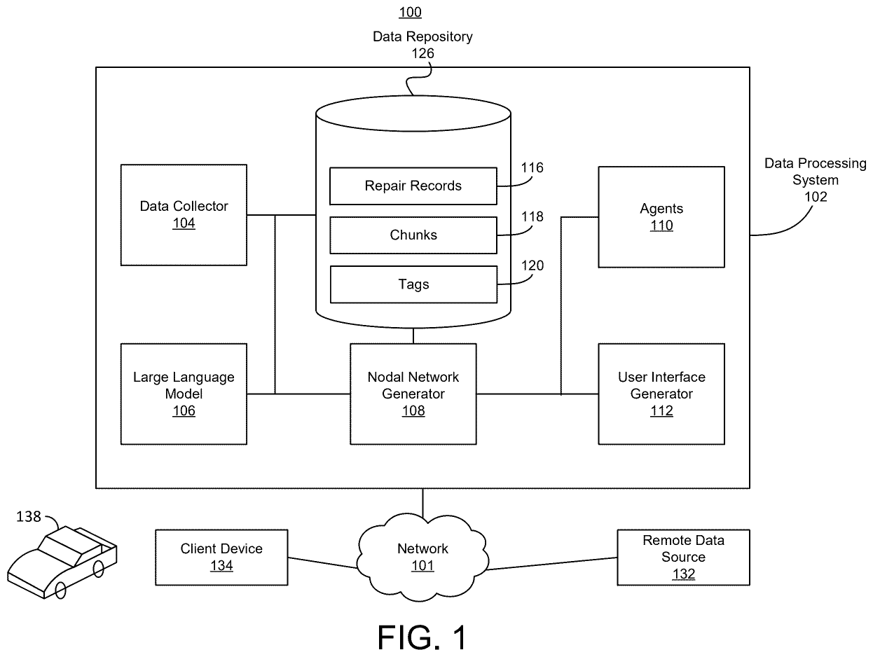

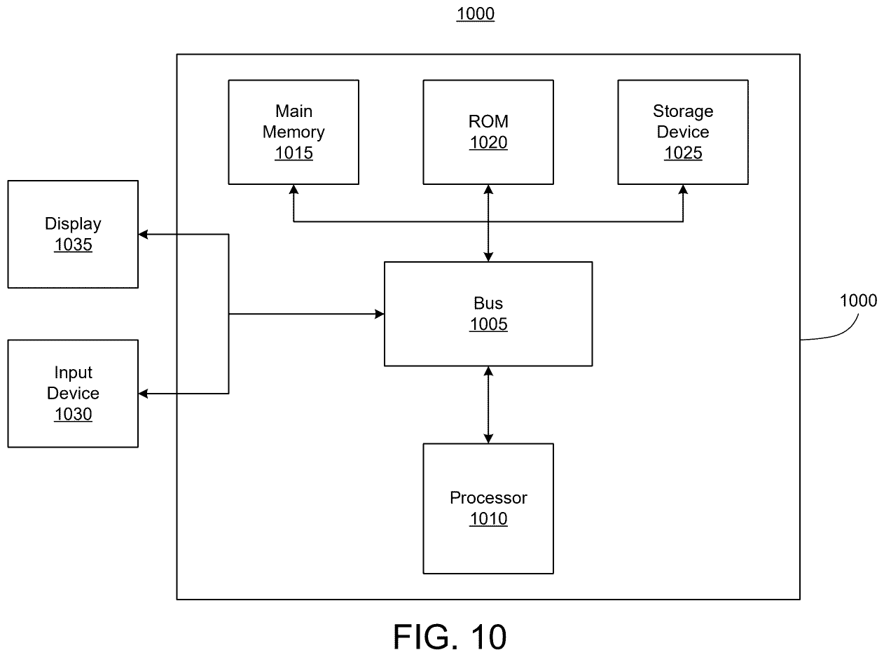

FIG. 1 is an illustration of an example system 100 of synchronizing a nodal network data structure, in accordance with implementations. The system 100 can include a data processing system 102. The data processing system 102 can communicate with one or more of a client device 134 or a remote data source 132 via a network 101. The network 101 can include computer networks such as the Internet, local, wide, metro, or other area networks, intranets, satellite networks, and other communication networks such as voice or data mobile telephone networks. The network 101 can be used to transmit or receive information from various information resources, such as web pages, web-based applications, software-as-a-service applications, or servers that can be provided, output, rendered or displayed on at least one client device 134. The client device 134 can include, for example, a desktop computer, laptop computer, tablet computer, smart phone, mobile telecommunication device, or portable computer. The client device 134 can include one or more components depicted in FIG. 10.

The network 101 can be any type or form of network and can include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 can include a wireless link, such as an infrared channel or satellite band. The topology of the network 101 can include a bus, star, or ring network topology. The network can include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data can be transmitted via different protocols, or the same types of data can be transmitted via different protocols.

The system 100 can include at least one data processing system 102. The data processing system 102 can include at least one logic device such as a computing device having a processor to communicate via the network 101, for example with the client device 134. The data processing system 102 can include at least one computation resource, server, processor, or memory. For example, the data processing system 102 can include a plurality of computation resources or servers located in at least one data center. The data processing system 102 can be part of or include a cloud computing environment. The data processing system 102 can include multiple, logically-grouped servers and facilitate distributed computing techniques. The logical group of servers can be referred to as a data center, server farm or a machine farm. The servers can also be geographically dispersed. A data center or machine farm can be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way can improve system manageability, data security, the physical security of the system, and system performance by locating servers and high performance storage systems on localized high performance networks. Centralization of all or some of the data processing system 102 components, including servers and storage systems, and coupling them with advanced system management tools allows more efficient use of server resources, which saves power and processing requirements and reduces bandwidth usage.

The data processing system 102 can interface with, communicate with or otherwise access one or more remote data sources 132. The remote data source 132 can be or include one or more data sources that store repair records, vehicle specifications, and/or external repair data. The remote data source 132 can be a database, a computer, a laptop, a server, or any other type of device that can store data. For example, the remote data source 132 can be or include a database (e.g., a relational or graph database) that stores a collection of previously processed repair records and their associated repair procedures (e.g., OEM repair manuals, technical service bulletins).

The remote data source 132 can store data indicating repair procedures and specifications for different vehicle components under different repair scenarios (e.g., collision types, damage severity). Examples of the repair scenarios can include varying impact locations, different material types, changing structural components, and/or different vehicle configurations. Each repair procedure can be represented as textual, numerical, and/or graphical content. For each repair scenario, the remote data source 132 can store data identifying the required repair steps, parts, or equipment for that scenario. The remote data source 132 can store such data for any number of repair procedures across different vehicle makes, models, or years. The remote data source 132 can generate and/or store repair information from a single manufacturer or from multiple manufacturers.

In some cases, the remote data source 132 can store data or metadata about individual repair procedures. For example, the remote data source 132 can store data indicating the complexity level (e.g., technician skill requirements and/or equipment requirements) of individual procedures and/or indications of whether specialized certifications are needed. The remote data source 132 can store any amount and/or type of data regarding repair procedures.

In one example, the remote data source 132 can include one or more data sources (e.g., as one or more computing devices at the same or different physical locations) for vehicle repair documentation in standardized formats. The remote data source 132 can store industry databases, such as OEM repair procedures, paint manufacturer specifications, and/or parts catalogs. The different databases can store repair procedures and/or can include repair sequence data showing the ordered steps for each repair operation, or quality control requirements with specific measurement values, along with metadata about repair conditions, part specifications, and/or technical requirements. The datasets may additionally or instead contain calibration procedures, torque specifications, and/or information about alternative repair methods or parts, depending on the vehicle configuration and repair requirements. The data can be generated from individual repair cases or from multiple repairs that involve documenting repair procedures under one or more scenarios.

The data processing system 102 can include, interface, or otherwise communicate with at least one data collector 104 (or data collector component). The data processing system 102 can include, interface, or otherwise communicate with at least one large language model 106 (e.g., a language model component). The data processing system 102 can include, interface, or otherwise communicate with one nodal network generator 108 (or nodal network generator component). The data processing system 102 can include, interface, or otherwise communicate with one or a plurality of agents 110 (or software agent components). The nodal network generator 108 can be an agent of the agents 110. The data processing system 102 can include, interface, or otherwise communicate with at least one user interface generator 112 (or user interface component). The data processing system 102 can include, interface, or otherwise communicate with at least one data repository 126.

The data collector 104, the large language model 106, the nodal network generator 108, the agents 110, or the user interface generator 112 can each include at least one processing unit or other logic device such as programmable logic array engine, or module configured to communicate with the data repository 126 or database. The data collector 104, the large language model 106, the nodal network generator 108, the agents 110, or the user interface generator 112 can be separate components, a single component, or part of the data processing system 102. The system 100 and its components, such as a data processing system 102, can include hardware elements, such as one or more processors, logic devices, or circuits.

The data repository 126 can include one or more local or distributed databases, and can include a database management system. The data repository 126 can include computer data storage or memory and can store one or more of repair records 116, chunks 118, or tags 120.

The repair records 116 can be or include different types of automotive or automotive repair data, documents, data structures, etc. For example, the repair records 116 can include original equipment manufacturer (OEM) repair manuals, OEM technical service bulletins, paint manufacturer specifications, parts catalogs, vehicle identification number (VIN) build sheets, or historical repair documentation. In some implementations, the repair records 116 can be stored in their original format and can include text documents, PDF files, XML files, or other structured and unstructured data formats. The repair records 116 can be versioned, with each version associated with metadata indicating its effective date, superseded documents, and applicable vehicle configurations. In some examples, the repair records 116 can include cross-references to related documents, such as when a technical service bulletin references specific sections of an OEM repair manual. The repair records 116 can each identify different types of vehicles. For instance, individual repair records 116 can each include identify a make, model, or year of the vehicles to which the repair records 116 correspond.

The chunks 118 can include domain-specific segments of the repair records 116 that have been preprocessed and formatted for efficient retrieval and analysis. In some cases, each chunk can correspond to one or more repair records 116, or portions of repair records 116, that describe on a specific vehicle system, component, or repair procedure. For example, a chunk 118 may include all information related to seatbelt assembly procedures, chassis alignment specifications, or body sealer application methods for a particular vehicle model. Each chunk can be associated with semantic embeddings generated by processing the chunk content through a large language model. The semantic embeddings can encode the technical meaning and context of the chunk content, facilitating similarity-based retrieval. In some cases, the chunks 118 can be or include structured JSON objects that maintain relationships between related repair procedures, such as dependencies between disassembly steps or calibration requirements.

The tags 120 can include metadata and classification information associated with both repair records 116 and chunks 118. In some implementations, tags can include vehicle part identifiers, repair operation codes, VIN range applicability, repair difficulty levels, technician skill requirements, required tools, or equipment specifications. Tags can be generated through automated processing of repair records using domain-specific ontologies that capture automotive repair terminology and relationships. For example, tags can identify synonymous terms (e.g., “bumper cover” and “fascia”), establish hierarchical relationships between components (e.g., “front bumper assembly” containing “impact absorber” and “reinforcement bar”), or capture the nuances between similar terms (e.g., the nuances between “steel” and “aluminum” panel repairs). In some examples, the tags 120 can include or correspond to timestamps, version identifiers, or audit trail information to track when and how repair information was modified. The tags 120 can be used by the data processing system 102's multi-agent framework to efficiently route relevant information to specialized agents and to validate consistency of repair operations across different information sources.

The data processing system 102 can include an interface (or interface component) designed, configured, constructed, or operational to communicate with the client device 134. The interface can receive and transmit information using one or more protocols, such as a network protocol. The interface can include a hardware interface, software interface, wired interface, or wireless interface. The interface can facilitate communication between one or more components of the data processing system 102. The interface can include or provide a user interface, such as a graphical user interface or frontend user interface. The interface can provide the user interface to a frontend interface via the client device 134.

The data processing system 102 can include a data collector 104 designed, constructed, and operational to receive, collect, identify, or otherwise obtain repair-related data. The data collector 104 can obtain data from one or more devices via the network 101, including, for example the client device 134, or the remote data source 132. The data collector 104 can receive data or information in any format, such as hypertext markup language (“HTML”), comma-separated values (e.g., .CSV), open extensible markup language (“XML”), technical repair manuals (e.g., PDF), diagnostic trouble codes (DTCs), vehicle images, or OEM specification documents.

The data collector 104 can receive or retrieve information from a remote data source 132. For example, the data collector 104 can transmit a request for data about different vehicles to the remote data source 132. Upon receiving the request, the remote data source 132 can retrieve the requested data of the request. The data collector 104 can identify or retrieve the requested data from memory and transmit the identified or retrieved data to the data processing system 102. In some cases, the remote data source 132 can transmit the data to the data collector 104 without receiving a request from the data collector 104. The remote data source 132 may do so, for example, in response to a user input.

In one example, the data collector 104 can receive or retrieve repair procedures from vehicle manufacturer technical information portals. For instance, the data collector 104 can transmit a request for occupant restraint repair procedures for a specific vehicle identification number (VIN) to the remote data source 132. Upon receiving the request, the remote data source 132 can locate the requested repair documentation. The data collector 104 can identify or retrieve the relevant seat belt mounting procedures and torque specifications from memory or a database and transmit the documents (e.g., digital documents or electronic documents) to the data processing system 102. The data collector 104 can receive the documents and store the documents in the data repository 126 as repair records 116.

The data collector 104 can similarly receive or retrieve any type of information about vehicles. For example, the data collector 104 can receive or retrieve one or more manufacturer specifications, technical service bulletins, or paint manufacturer guidelines from one or more remote data sources 132. In some cases, the data collector 104 can similarly receive or retrieve such data from the client device 134 or another computing device accessed by a user. The data collector 104 can store the received data in the data repository 126 as the repair records 116. The data collector 104 can repeat this process over time. Accordingly, the data collector 104 can facilitate the real-time management of data regarding different vehicles.

The large language model 106 can be a neural network, a transformer, a small language model, or any other type of machine learning model that is configured or trained to generate text or other types of outputs in response to natural language queries or other types of inputs. In one example, the large language model 106 can be or include a neural network architecture having parameters trained through self-supervised learning on text corpora. The large language model 106 can be trained or configured to input sequences through multiple transformer layers to generate contextually appropriate output tokens based on learned statistical patterns and semantic relationships. The large language model 106 can include an embedding layer and a decoding layer. The embedding layer can be configured to generate embeddings, or vector representations, of inputs. The decoding layer can be trained or configured to process such embeddings to generate outputs.

The data collector 104 can use a large language model 106 to store the received data in the data repository 126. For example, the data repository 126 can be or include a vector database or a retrieval-augmented generation (RAG) database. The data collector 104 can input the separate records or documents regarding vehicle data that the data collector 104 receives from the remote data source 132 or the client device 134 into the large language model 106. The data collector 104 can execute the large language model 106 for each input to generate an embedding for each record or document that the data collector 104 receives. The large language model 106 can do so, for example, by generating embeddings for the records or documents using the embedding layer of the large language model 106. The embeddings can represent the contents of the respective records or documents. The large language model 106 or the data collector 104 can store the embeddings in the data repository 126 with the records or documents to which the embeddings correspond. In doing so, the data collector 104 or the large language model 106 can store the records or documents in the data repository 126 with vectors indicating the contents of the respective records or documents (e.g., the repair records 116).

In some cases, the data collector 104 can generate or store the chunks 118 of the contents of the repair records 116 in the data repository 126. In doing so, the data collector 104 can segment repair documents into coherent, semantically meaningful units. The data collector 104 can process input documents including OEM manuals, technical service bulletins, paint manufacturer specifications, and parts catalogs to generate domain-specific chunks that are optimized for retrieval and processing by the multi-agent system. Each domain can be or correspond to a particular vehicle part or process.

The data collector 104 can segment documents based on automotive-relevant boundaries, such that each chunk corresponds to a specific vehicle system, component, or repair procedure. For example, the data collector 104 can create separate chunks for sections of individual documents describing seatbelt assembly procedures, chassis alignment specifications, or paint application methods. In some implementations, the data collector 104 can identify these boundaries using domain-specific rules and automotive repair ontologies that define relationships between repair concepts.

For each generated chunk, the data collector 104 can assign metadata tags (e.g., the tags 120) that facilitate efficient retrieval and processing. The tags can be strings or values. These tags can include, for example, one or more identifications of associated VIN ranges, repair difficulty levels, required technician certifications, necessary tools and equipment, and relationships to other repair procedures. The data collector 104 can also identify and tag synonymous terms (e.g., “bumper cover” and “fascia”) and establish hierarchical relationships between components (e.g., “front bumper assembly” containing “impact absorber” and “reinforcement bar”).

The data collector 104 can generate an embedding (e.g., a semantic embedding) for each chunk using the large language model 106. For example, the data collector 104 can identify individual chunks from individual documents or files and provide the chunks to the large language model 106 as input. The large language model 106 can generate (e.g., out of the embedding layer) an embedding for each input chunk. These embeddings can encode the technical meaning and context of the content of the respective chunks. The embeddings can be used for subsequent similarity-based retrieval. The data collector 104 can store these embeddings in the data repository 126 alongside the chunks (e.g., the chunks 118), allowing for efficient semantic search and retrieval of relevant repair information.

The data collector 104 can combine data from different documents or files into individual chunks. For example, the data collector 104 can use a natural language processing protocol to identify portions of different received data or the repair records 116 that correspond to a particular domain or part of a vehicle. The data collector 104 can do so, for example, by determining (e.g., using the large language model 106 or other types of natural language processing protocols) contexts of the separate portions. The contexts can be or correspond to the same domain or part of a vehicle. The data collector 104 can extract text, paragraphs, tables, instructions, graphs, etc., determined to have the same context. The data collector 104 can append the extracted data to each other, such as by generating a file that includes the extracted data determined to correspond to the same context. The data collector 104 can then generate an embedding from the data that was appended together using the large language model 106. The data collector 104 can store the chunk with the embedding in the data repository 126. The data collector 104 can include data from one or more records or documents in the chunk. The data collector 104 can additionally or instead generate a tag identifying the context (e.g., as a plain language string) and store the tag with the chunk. The data collector 104 can repeat this process for any number of chunks.

The data processing system 102 can include a user interface generator 112 designed, constructed, and operational to generate or update a user interface displayed at computing devices remote from the data processing system. The user interface generator 112 can be configured to generate a user interface that illustrates a process or instructions for a process for repairing or performing maintenance on a vehicle. In doing so, the user interface generator 112 can generate a user interface of a platform provided by the data processing system 102. The platform can be a software service (e.g., a software-as-a-service platform), application, or website that can be accessed by remote computing devices from the data processing system. For example, remote computing devices can execute applications (e.g., browsers or application programming interfaces (APIs)) that are configured to communicate with the data processing system. Such remote computing devices can connect with the data processing system 102 through the applications. The user interface generator 112 can generate user interfaces of the platform and transmit the user interfaces to the connected remote computing. Through the user interfaces, users can provide inputs to access different pages or views and the user interface generator 112 can update the user interfaces based on the inputs. For instance, through a user interface transmitted to the client device 134, a user can input vehicle damage data of a vehicle involved in a collision. The data processing system can execute the components 104-110 to generate a visual representation of a repair process for repairing the vehicle damage. The user interface generator 112 can generate the user interfaces providing the user with the opportunity to provide inputs and update the user interfaces to depict the generated visual representations of the repair process for repairing the vehicle.

The data processing system 102 can include a nodal network generator 108 designed, constructed, and operational to generate or update a user interface displayed at computing devices remote from the data processing system. The nodal network generator 108 can be configured to generate a nodal network data structure that simulates or represents a process for repairing damage to a vehicle. The nodal network data structure can be or include a graph with nodes that represent the process or sequence of repairing a vehicle, such as repairing a vehicle after the vehicle has been in a collision or repairing a vehicle that is receiving maintenance. The nodal network data structure can include one or more nodes that correspond to operations for repairing a vehicle (e.g., operation nodes), one or more nodes that correspond to the tools used to perform such operations (e.g., tool nodes), one or more nodes that correspond to parts that are used for the operations (e.g., part nodes), or one or more nodes that include metadata about the operations (e.g., metadata nodes). Examples of metadata may include costs, time to complete, risks, special instructions, etc. Tool nodes and part nodes can each be examples of equipment nodes. Another type of node can include inspection checkpoint nodes (e.g., inspection nodes).

Each of the nodes can be or include a data structure. The data structure can be or include a table, a matrix, a form, or any other type of data structure. The data structures can include separate fields that correspond to different types of data. For instance, a data structure of an operation node may have fields that are respectively dedicated to inserting addresses, pointers, or identifiers of tool nodes, metadata nodes, part nodes, or operation nodes. The operation nodes can be connected with other nodes with identifiers that are inserted or placed in the fields. The data structures can additionally or instead include data about the operation, tool, metadata, or part to which the data structures correspond. For instance, the data structures can each include text or other types of content indicating or identifying an operation to perform (for operation nodes), a tool to use (for tool nodes), a part to use (for part nodes), or metadata about an operation (for metadata nodes). In some cases, the nodes can include pointers, hyperlinks, or addresses of the repair records 116 or chunks 118 that contain the data from which the data structures of the nodes were generated. Such pointers or addresses can be used to verify the contents or the existence of the respective nodes.

The nodes within the nodal network data structure can be connected by edges. For example, individual operation nodes can each be connected with one or more tool nodes, one or more metadata nodes, or one or more part nodes. For instance, an operation node may be connected with tool nodes that represent the tools that are needed or relevant to performing the operation of the operation node, part nodes that represent parts that are needed or relevant to performing the operation of the operation node, or a metadata node that describes metadata regarding performing the operation. The edges between nodes can be created by inserting identifiers of the other nodes of the edges into the nodes. For example, a node A may have an edge with node B. To create the edge, node A may store an identifier of node B and node B may store an identifier of node A. Such identifiers may be stored in the fields of nodes dedicated to storing identifiers of types of nodes on the other side of the edges. Any number of tool nodes, metadata nodes, or part nodes may be linked or share edges with individual operation nodes in this way.

The operation nodes (e.g., only the operation nodes) may share edges with other operation nodes. The edges may be directional or sequential, indicating an order in which to perform the operations of the operation nodes. The order may be indicated by a numerical value in the respective nodes that increase or increment in sequence for each operation of the sequence in the order in which the sequence is to be performed. Such numerical values may be stored in fields of the operation nodes dedicated to storing the numerical values. In some cases, operation nodes may only share edges with individual operation nodes, and the tool nodes, part nodes, and metadata nodes may each only be linked to the operation nodes to which those nodes correspond.

In an example, a nodal network data structure may represent or simulate a front bumper replacement repair procedure. An operation node labeled “Remove_Front_Bumper_Cover” can be connected via edges to multiple other nodes within the nodal network data structure. This operation node can be connected to tool nodes including “10 mm_Socket_Wrench” and “Plastic_Trim_Removal_Tool,” which represent the tools required for the bumper cover removal. The operation node can also be connected to part nodes such as “Front_Bumper_Clips” and “Lower_Splash_Shield_Fasteners” that identify the parts involved in the operation. Additionally, the operation node can be connected to a metadata node containing specific torque specifications and noting that the vehicle must be properly supported on a lift before beginning the procedure.

The edges between these nodes can be created through a system of identifiers. For example, the “Remove_Front_Bumper_Cover” operation node can store identifiers “TOOL_10 MM_SOCKET” and “TOOL_TRIM_REMOVAL” in its tool-related fields, while the corresponding tool nodes store the identifier “OP_BUMPER_REMOVAL” in their operation-related fields. Similarly, the part nodes can store the operation identifier in their fields, and the operation node can store the part identifiers “PART_CLIPS_FRONT” and “PART_FASTENERS_SPLASH” in its part-related fields.

In this example, the “Remove_Front_Bumper_Cover” operation node can also share directional edges with other operation nodes in the repair sequence. It can have an edge connecting to a preceding operation node “Disconnect_Front_Sensors” (sequence value 1) and to a subsequent operation node “Remove_Impact_Absorber” (sequence value 3), with the bumper cover removal itself having sequence value 2. These sequence values can be stored in a dedicated “sequence_number” field within each operation node, establishing the required order of operations. The tool nodes (such as “10 mm_Socket_Wrench”), part nodes (such as “Front_Bumper_Clips”), and metadata nodes (containing torque specifications) are connected only to their relevant operation nodes and not to each other, maintaining a hierarchical structure in the repair procedure.

The data processing system 102 can include agents 110 each designed, constructed, and operational to perform a different task involving generating and/or processing data of nodal network data structures represent repair processes. Although shown separately, the nodal network generator 108 can be or include one or more agents or one or more replicants of the agents 110. The agents 110 can each or include, for example, machine learning models, such as large language models, that are configured to automatically process inputs to generate outputs to perform tasks for which the agents are trained or to which the agents are assigned. The agents 110 can be or include replicants, which may each be multi-agent artificial intelligence entities that include modules or agents (e.g., perception, attention, executive, memory, etc.). The modules or agents can correspond to neurological tasks that can be performed by a human brain. The agents 110 can communicate with each other through a message bus or “blackboard” system in which each agents post tasks, insights, or requests that other agents 110 can view or ingest to determine a next step to generating or updating a nodal network data structure representing a vehicle repair process.

Examples of different agents that may be included in the agents 110 can be a perception agent, an attention agent, an executive agent, and a memory agent. The perception agent can process input data received by the data collector 104 including repair documentation, technical bulletins, vehicle identification information, and damage assessment data. For example, the perception agent can scan and analyze repair manuals to extract repair procedures, analyze damage photos to identify affected components, and process vehicle identification numbers to determine specific model characteristics. The perception agent can output the processed information to other agents through the message bus for further analysis and integration into a nodal network data structure.

The attention agent can maintain focus on relevant repair contexts and identify critical inspection points within the repair process. For example, the attention agent can monitor incoming damage reports to flag areas requiring detailed inspection, track dependencies between repair steps, and maintain awareness of safety-critical components that may be affected by the repair. The attention agent can communicate priority areas and potential concerns to other agents through the message bus to ensure comprehensive repair planning.

The executive agent can coordinate decision-making and manage the sequencing of repair operations. For example, the executive agent can determine the optimal order of repair steps, allocate resources based on repair requirements, and adjust repair plans when new damage is discovered. The executive agent can initiate new assignments, coordinate between multiple repair operations, and ensure all necessary steps are included in the repair plan through the message bus.

The memory agent can store and retrieve historical repair information to inform current repair decisions. For example, the memory agent can identify patterns from similar past repairs, recall specific repair procedures that were successful for comparable damage scenarios, and maintain a record of repair modifications and outcomes. The memory agent can share relevant historical insights through the message bus to help other agents make informed decisions about current repair strategies.

These agents work together through the message bus architecture, with each agent contributing its specialized function to maintain and update the digital twin model. For example, the perception agent may identify new damage, the attention agent can flag the identified new damage as high priority, the executive agent can adjust the repair sequence accordingly, and the memory agent can identify relevant historical repair data for similar damage patterns.

The agents 110 can be formed into separate replicants. For example, the agents 110 can be divided into a researcher replicant, a verification replicant, or a manager replicant. Each replicant can internally include sub-agents for tasks like perception (document scanning), attention (maintaining context), executive (decision-making and scheduling), and memory (long-term data retention). A researcher replicant can retrieve and analyze repair-related information from the data repository 126 by combining multiple core agents. For example, when presented with a new repair scenario, the researcher replicant can use its perception agent to process repair documentation, its attention agent to focus on relevant vehicle systems, its executive agent to formulate research queries, and its memory agent to correlate findings with historical repair data. The researcher replicant can transmit the gathered repair procedures and specifications through the message bus for use by other replicants in building and maintaining a nodal network data structure.

The verification replicant can validate repair procedures and ensure compliance with manufacturer specifications and safety requirements. For example, when reviewing a proposed repair plan, the verification replicant utilizes its perception agent to analyze the suggested procedures, its attention agent to analyze safety-critical components and compliance requirements, its executive agent to compare procedures against OEM standards, and its memory agent to reference previous validation outcomes. The verification replicant can flag discrepancies and suggest corrections through the message bus to maintain repair plan accuracy and safety compliance.

A manager replicant can coordinate the overall repair process and resource allocation. For example, when overseeing a repair operation, the manager replicant can use its perception agent to monitor repair status updates, its attention agent to track multiple concurrent tasks and dependencies, its executive agent to adjust repair sequences and resource assignments, and its memory agent to optimize scheduling based on historical repair timing data. The manager replicant can update the nodal network data structure through the message bus to reflect real-time changes in the repair plan and resource allocation.

These replicants can operate in tandem as a coordinated crew when generating and updating a nodal network data structure representing the repair process. For example, when processing a new repair case, the researcher replicant can retrieve relevant repair procedures. The verification replicant can validate the repair procedures against current specifications. The manager replicant can use this validated information to create and maintain the repair schedule. If new damage is discovered during the repair process, all three replicants can automatically update their functions. For instance, the researcher replicant can gather additional repair procedures, the verification replicant can validate the new procedures, and the manager replicant can adjust the repair plan accordingly. This coordination can be facilitated through the message bus, facilitating real-time synchronization of the nodal network data structure as the repair progresses. As the data processing system 102 gains more experience, the data processing system 102 can update how crews are formed (e.g., by learning different combinations of sub-agents that work best for specific tasks).

The nodal network generator 108 can generate nodal network data structures that represent different vehicle repair procedures. The nodal network generator 108 can do so as one or more of a researcher replicant, a validation replicant, or a manager replicant, for example. The nodal network generator 108 can generate nodal network data structures based on the repair records 116 or the chunks 118 stored in the data repository 126 that the nodal network generator 108 retrieves from the data repository 126. For example, the nodal network generator 108 can retrieve a chunk or set of repair records 116 that corresponds to a dented front bumper or a bumper replacement. The nodal network generator 108 can be or include a large language model and process each of the retrieved chunks 118 or repair records 116. In some cases, the nodal network generator 108 can process the retrieved chunks 118 or repair records 116 using the large language model 106. In doing so, the nodal network generator 108 can identify or determine succinct operations that are involved in replacing or otherwise mitigating (e.g., repairing) the damage to the front bumper.

For each operation that is involved in replacing or otherwise mitigating the damage to the front bumper, the nodal network generator 108 can identify different aspects or characteristics of the operation. For instance, the nodal network generator 108 can identify equipment (e.g., tools or vehicle parts, such as a torque wrench or a replacement bumper) that is required to perform the operation or other types of metadata or properties, such as duration or process requirements of performing the operation. The nodal network generator 108 can generate the nodes for the operation by generating an operation node for the operation and generating separate nodes for the equipment or metadata of the operation.

When generating the nodes for the operation, the nodal network generator 108 can include a text description or identifier of each node in the data structure of each node and/or identifiers of other nodes to which the nodes are linked through edges. The edges can identify relationships between nodes (e.g., “to repair the front bumper, remove headlamp assembly first”). For example, if the first operation is to remove a bumper from a vehicle, the nodal network generator 108 can generate an operation with an identification or text string indicating to remove the bumper, generate one or more tool nodes identifying the tools needed to remove the bumper, and one or more metadata nodes indicating metadata about the operation, such as the amount of time it will take to remove the bumper or instructions for removing the bumper. The operation node may be linked to each of the tool nodes and the metadata nodes through edges. The nodal network generator 108 can similarly generate operation nodes for each operation that the nodal network generator 108 as part of the process to repair the dented bumper.

When generating the operation nodes, the nodal network generator 108 can generate the operation nodes in the sequence of the repairing process. For example, the nodal network generator 108 can insert sequence number identifiers identifying the location or place of each operation node in the sequence of operations to repair the broken bumper. By formatting the nodal network data structure in this way, the nodal network generator 108 can generate an input for the large language model 106 that the large language model 106 can use to depict or illustrate the real-world steps for repairing the bumper.

In some cases, the nodal network generator 108 can generate the nodal network data structure using a plurality of agents 110. The agents 110 may be agents of the nodal network generator 108 as a replicant, in some cases. For example, a first agent of the nodal network generator 108 may be trained to parse repair records using a natural language processing protocol (e.g., sentiment analysis, text analysis, entity identification, a large language model, etc.). A second agent of the nodal network generator 108 may be trained to generate nodes in the nodal network data structure based on language extracted from repair records. Accordingly, the first agent may extract language from the repair records 116 and the second agent may use the extracted language to generate and organize nodes within the nodal network data structure.

In some cases, multiple agents of the nodal network generator 108 may be trained to generate nodes within the nodal network data structure. Such can be the case, for example, to increase efficiency and speed of generating the nodal network data structure. For example, individual agents may process the same or a different combination of repair records 116 or chunks 118 to determine which or whether to generate nodes when the nodal network data structure. In doing so, the two agents may make opposite determinations about whether to generate a node for an operation (e.g., one agent determines to generate the node for the operation and the other agent determines not to generate the node for the operation), which may be caused by the agents being trained based on different training data or the agents processing different records. The agents may similarly make different determinations about any other type of node. Responsive to this occurrence, the data processing system 102 may detect a conflict. Responsive to detecting the conflict, the data processing system 102, the nodal network generator 108, or an agent of the nodal network generator 108 may generate an alert identifying the conflict, such as by using the large language model 106 or another large language model.

The alert may be an audible alert or a visual alert that the data processing system 102 transmits to the client device 134. In the case of an audible alert, the alert can cause sound to emit out of a speaker of or attached to the client device 134 indicating an error, in some cases with words indicating the operation that is causing the error. In the case of a visual alert, the user interface generator 112 can generate a user interface identifying the error (e.g., including an error code for the error that corresponds to the conflict). The user interface generator 112 can additionally or instead indicate or identify the operation that is causing the error or the source of the data based on which the agents generated their decisions regarding the operation. The user interface generator 112 can populate the user interface with any such data and transmit the updated user interface to the client device 134. The client device 134 can display the user interface on a display.

In some cases, by generating and transmitting the user interface to the client device 134, the user interface generator 112 can cause the populated to appear on a chat interface of the user interface that a user of the client device 134 was using to provide inputs or otherwise communicate with the data processing system. Such can be the case, for example, when the user requests for a visual representation of a process to repair a vehicle by providing a natural language query to the chat interface at the client device 134 with any other data regarding damage to the vehicle that needs to be repaired. In doing so, the user interface generator 112 can provide real-time updates to the user regarding the generation of the visual representation of the process for repairing the vehicle.

In some cases, the user at the client device 134 can provide feedback to the data processing system 102 that can be used to resolve the conflict. For example, the user at the client device 134 can view the data regarding the conflict from the alert. The user can provide an input indicating whether or not to include the operation in the process for repairing the vehicle. The data processing system 102 can receive the input from the client device 134, and the nodal network generator 108 can operate according to the input (e.g., generate a node for the operation or continue generating the nodal network data structure without generating a node for the operation). Accordingly, the data processing system can use agents to generate the nodal network data structure with less latency and more efficiently than other methods while maintaining the validity of the nodal network data structure using an external data source as a ground truth.

In some cases, instead of or in addition to resolving the conflict between the pair of agents by transmitting the alert to the client device 134, the conflicting agents or a third agent (e.g., an executive agent) of the nodal network generator 108 can use the repair records 116 or chunks 118 in the data repository 126 to resolve the conflict. For example, responsive to detecting the conflict, an agent of the nodal network generator 108 may query the repair records 116 or chunks 118 of the data repository 126 for repair records 116 or chunks 118 related to the conflict. To do so, for example, the agent can input text representing the decisions or the relevant operation of the conflict to generate an embedding and use the generated embedding to query the data repository 126 for one or more repair records 116 or chunks 118 with the highest similarity to the embedding. In another example, the agent can identify or retrieve the repair records 116 or chunks 118 that each of the pair of agents used to generate their respective decisions. The agent can use any technique to retrieve the relevant repair records 116 or chunks 118 from the data repository 126.

The agent can use the retrieved records 116 or chunks 118 to perform a second determination as to whether to generate a node in the node graph for the operation associated with the conflict between the pair of agents. The agent can do so, for example, by inputting the retrieved records 116 or chunks 118 into the large language model 106 and executing the large language model 106 with instructions to generate a determination regarding whether to generate the operation. In some cases, the agent can provide context with the input by inputting a current state of the nodes of the nodal network data structure, which the large language model 106 can use to determine whether the operation in question is already in the nodal network data structure or will otherwise be resolved by an operation represented by a node within the nodal network data structure. The large language model 106 can apply learned weights or metrics to the input to generate an output indicating whether to generate a node for the operation or not or otherwise how to refine such a node for the operation (e.g., generate a node for the operation but configure the node differently such that the operation is a variation from the node initially proposed by the agent of the nodal network generator 108 of the conflict). The agent of the nodal network generator 108 can identify the output determination and operate accordingly (e.g., insert the node into the nodal network data structure according to a determination to do so or otherwise emit the node from the nodal network data structure according to a determination not to include the node in the nodal network data structure). Because the agent may use more data than the two agents to determine whether to generate the node in the nodal network data structure, the agent may be able to more accurately determine whether to generate the node. The agent may only be used in this way upon detection of a conflict, however, to reduce the processing resources involved in processing the further data.

In some cases, the data processing system may use a combination of retrieved repair records 116 or chunks 118 with an alert to resolve the conflict. For example, instead of directly resolving the conflict based on the retrieved records 116 or chunks 118, the nodal network generator 108 can determine input data that can be used to resolve the conflict.

Instead of inputting an indication directly identifying whether or not to generate the node in the nodal network data structure, the user can provide an input including vehicle data that the nodal network generator 108 can use to resolve the conflict. For example, in the alert, the user interface generator 112 can include a request (e.g., a text request) for input data regarding the vehicle. The user interface generator 112 can generate the request based on the output from the large language model 106. For instance, the large language model 106 can output an indication that more information is needed to determine whether to generate a node in the nodal network data structure. An example of when the large language model 106 can generate such an indication, is when the conflict is regarding whether to correct a “minor bend” in a bracket. For instance, a conflict may arise when one repair record indicates that a minor bend is acceptable while another repair record indicates a replacement bracket is needed if a bracket is deformed by more than two millimeters. The large language model 106 may generate an output indicating more information is needed about the size of the bend. In response, the user interface generator 112 can generate (e.g., using a large language model or a stored set of text requests) a text request for the user to measure the bend. The user interface generator 112 can include the text request in the user interface generated by the user interface generator 112 and transmit the user interface to the client device 124 for presentation.

The user accessing the client device 124 can view the text request and provide an input indicating the requested information. For instance, the user can provide an input of “three millimeters.” The client device 134 can transmit the input to the data processing system 102.

The nodal network generator 108 can process the input to determine whether to generate a node for repairing or replacing the bracket. To do so, the nodal network generator 108 can compare the input data to the conflicting rules from the repair records 116 or the chunks 118 and determine whether the input data indicates a repair operation is needed or not needed. Responsive to determining a repair operation is needed, the nodal network generator 108 can generate the node for the operation in the nodal network data structure. Otherwise, the nodal network generator 108 may omit the node from the nodal network data structure. Such a conflict and resolution technique may occur when using one or more agents to generate the nodal network data structure.

The user interface generator 112 can use a generated nodal network data structure to generate a visual representation of the process represented by the nodal network data structure for display on a user interface. For example, responsive to the nodal network generator 108 generating the nodal network data structure, the user interface generator 112 can input the nodal network data structure into a large language model, such as the large language model 106 or a different large language model. The user interface generator 112 can include instructions with the nodal network data structure indicating a format in which to generate a visual representation of the nodal network data structure. Such instructions can include formats such as a text format, a video format, a picture format, a sequence of pictures format, a comic strip format, etc. The user interface generator 112 can execute the large language model 106 based on the input to cause the large language model 106 to generate the visual representation of the nodal network data structure in the requested format. The user interface generator 112 can generate a user interface to include the generated visual representation.

In some cases, the user interface generator 112 can generate a feature vector or a prompt with the nodal network data structure or the requested format. The user interface generator 112 can do so by extracting the data from the nodal network data structure and placing the extracted data into a new format. The user interface generator 112 can place the extracted data into the new format according to a stored template of the user interface generator 112. For example, a template may identify specific locations in a prompt to include operations and corresponding locations to include data about the locations, in some cases organized by the type of the data (e.g., tools, parts, metadata, etc.). The user interface generator 112 can extract the data from the nodal network data structure and generate a prompt according to the format of the template. The user interface generator 112 can include instructions indicating a format in which to generate a visual representation of the data extracted from the nodal network data structure in the prompt (e.g., in a dedicated location of the prompt according to the template). The user interface generator 112 can input the prompt into the large language model 106 and execute the large language model 106 to cause the large language model 106 to generate the visual representation of the extracted data from the nodal network data structure.

The nodal network generator 108 can update the nodal network data structure. The nodal network generator 108 can do so in response to receiving further information about the vehicle undergoing the repair process. For example, as a technician is repairing a vehicle the technician may identify new information about the vehicle. The new information may indicate that there is further damage to the vehicle than was previously known when the nodal network generator 108 generated the initial nodal network data structure. The technician can provide an input indicating the new information into the client device 134. The client device 134 can transmit the new information to the data processing system 102. The nodal network generator 108 can retrieve relevant repair records 116 or chunks 118 to the new information. The nodal network generator 108 can execute the large language model 106 using the retrieved repair records 116 or chunks 118 as input to generate an output indicating one or more operations or data (e.g., tools, parts, equipment, metadata, etc.) about the operations that correspond to the new information. For instance, the large language model 106 can generate an output identifying one or more operations for repairing a wire that the technical found was broken after removing a bumper from the vehicle.

The nodal network generator 108 can use the generated operations to update the initial nodal network data structure. For example, the nodal network generator 108 can execute the large language model 106 or another large language model using the generated operations and the initial nodal network data structure as input. In doing so, the nodal network generator 108 can identify an operation of the initial nodal network data structure to connect to the generated operations. For instance, the nodal network generator 108 can generate an initial nodal network data structure including operation nodes for operations A, B, C, and D. The operation nodes are in sequential order. The nodal network generator 108 can determine operations E and F. The nodal network generator 108 can determine operation E and F are to occur after operation C. The nodal network generator 108 can do so, for example, based on an input indicating the technician found the additional damage while performing the operation corresponding to operation C or based on a context of operation C having a high similarity to a context of operation E, which can be determined by a large language model, such as by generating embeddings of the operations and determining a highest similarity between operations C and E. Accordingly, the nodal network generator 108 can update the nodal network data structure such that the nodal network data structure includes operation nodes for operations in the order of A, B, C, E, F, and D. In doing so, the nodal network generator 108 can generate the operation nodes E and F in the manner described above and update the sequence numbers for operation D to indicate operation is to be performed after operation E and F. The nodal network generator 108 can similarly update the nodal network data structure to include any other types of nodes to connect with the operation E and F.

The user interface generator 112 can generate an updated visual representation of the updated nodal network data structure. For example, the user interface generator 112 can use the updated nodal network data structure as input into the large language model 106 or another large language model as described above and execute the large language model 106. Based on the execution, the large language model 106 can generate an updated visual representation (e.g., a second visual representation) of the updated nodal network data structure. The user interface generator 112 can present the updated visual representation of the updated nodal network data structure on a user interface at the client device 134. The data processing system 102 can repeat this process any number of times as the data processing system 102 receives further inputs.

In some cases, the nodal network generator 108 can use the nodal network data structure to maintain a state of a repair process. For example, after generating the visual representation of the nodal network data structure for display at the client device, a technician viewing the visual representation may provide inputs regarding notes or statues of the different operations represented by the nodes. For instance, the technician can provide inputs indicating the operation the technician is currently performing or operations that the technician has completed. The nodal network generator 108 can receive such inputs and update the respective nodes (e.g., the data structures of the nodes) to indicate the status updates. Such may be advantageous, for example, when updating the nodal network data structure based on additional damage data, because the status updates can be used as input into the large language model 106 and can be used to determine the node to link to new nodes for any new operations that need to be performed to address the newly identified damage. The large language model 106 or the nodal network generator 108 may determine to link (e.g., generate an edge between) the new node and the most recent node that the technician provided input indicating a complete operation or that the technician is currently performing.

In an example, the client device 134 may establish a connection with the data processing system 102. The client device 134 may be accessed by a technician at a repair shop that is repairing a vehicle 138 that was in a collision. In doing so, the technician can access a user interface generated by the user interface generator 112 that includes forms (e.g., fields into which the technician can input values or check boxes that the technician can select) to indicate the damage to the vehicle 138. The technician can input values indicating initial vehicle damage data that includes the location of the damage (e.g., a specific location or part of the vehicle 138). For example, the technician can provide an input indicating that a headlight is broken on the vehicle. The technician can also input a VIN of the vehicle 138. The client device 134 can transmit the VIN and the initial vehicle damage data to the data processing system 102.

The nodal network generator 108 can use the large language model 106 to retrieve repair records 116 or chunks 118 that are relevant to or otherwise correspond to the initial vehicle damage data and the VIN. To do so, for example, the nodal network generator 108 can input the received initial vehicle damage data or the VIN into the large language model 106 and execute the large language model 106 to generate an embedding (e.g., out of the embedding layer of the large language model 106) that represents the initial vehicle damage data and the VIN. Including the VIN in the input can cause the embedding to correspond to specific information about the vehicle itself, such as the manufacturer, year, make, and model of the vehicle, which can cause any queries with the embedding generated from the VIN to retrieve records or chunks that are more relevant to the vehicle 138. In some cases, the user can provide data about the vehicle (e.g., year, make, model) and the nodal network generator 108 can include such data in the input into the large language model 106. The large language model 106 or the nodal network generator 108 can use the embedding to query the repair records 116 or the chunks 118. In doing so, the large language model 106 can compare the embedding with the stored embeddings for each of the respective repair records 116 or chunks 118 to determine a similarity for each of the repair records 116 or chunks 118 with the embedding of the vehicle damage data and vehicle identification information. The large language model 106 or the nodal network generator 108 can identify one or more of the repair records or chunks 118 that correspond with the highest similarity.

In some cases, the large language model 106 or the nodal network generator 108 can filter the repair records 116 or the chunks 118 prior to use RAG retrieval techniques to retrieve the relevant repair records 116 or chunks 118. The large language model 106 or the nodal network generator 108 may do so, for example, based on the tags 120 stored with the respective repair records 116 or chunks 118. For example, the large language model 106 or the nodal network generator 108 may identify a location or damaged part of a vehicle for which the nodal network generator 108 is generating a nodal network data structure for repairing the vehicle. The large language model 106 or the nodal network generator 108 can perform a query using an identification of the location or damaged part of the tags 120. The large language model 106 or the nodal network generator 108 may identify one or more repair records 116 or chunks 118 that correspond to a matching tag, if any. The large language model 106 or the nodal network generator 108 can generate an embedding from the initial vehicle damage data or the VIN and only query the identified repair records 116 or chunks 118. In doing so, the query with the embeddings can substantially reduce the processing resources required to perform the query because the number of similarity calculations and matching is reduced.

The nodal network generator 108 can parse the retrieved repair records 116 or chunks 118 using natural language processing techniques or a large language model (e.g., the large language model 106). In doing so, the nodal network generator 108 can generate or identify one or more operations of a process for repairing the initially identified damage to the vehicle 138. The nodal network generator 108 can generate a nodal network data structure that includes the operations represented by operation nodes in order that share edges with nodes representing different types of data about the operations.

The user interface generator 112 can use the large language model 106 to generate a first visual representation of the repair process represented by the nodal network data structure. The user interface generator 112 can do so by inputting the nodal network data structure directly into the large language model 106 with instructions to generate the first visual representation of the repair process or by generating a prompt using a template and the data of the nodal network data structure. The user interface generator 112 can provide the input into the large language model 106 and execute the large language model 106 to generate the first visual representation of the repair process.

The user interface generator 112 can generate a user interface including the first visual representation of the repair process and display the user interface at the client device 134. The technician accessing the client device can view the user interface and begin repairing the vehicle 138 following the operations of the nodal network data structure depicted in the first visual representation on the user interface. In doing so, the technician may identify additional damage to the vehicle 138, such as a wire that was broken or a spark plug that was not operational. The technician can provide an input into the client device 134 indicating such data. The client device 134 can transmit the additional vehicle damage data to the data processing system 102.

The nodal network generator 108 can identify the additional vehicle damage data and use the large language model 106 to generate an embedding from the additional vehicle damage data, in some cases with the previously received VIN of the vehicle 138 or initial damage data. The large language model 106 or the nodal network generator 108 can query the data repository 126 using the newly generated embedding to retrieve one or more additional repair records 116 or chunks 118 that are relevant to repairing the newly identified vehicle damage.

The nodal network generator 108 can use the additional repair records 116 or chunks 118 to update the nodal network data structure generated to simulate the repair process for repairing the vehicle 138. For example, the nodal network generator 108 can parse the retrieved additional repair records 116 to identify one or more operations to perform to repair the additional vehicle damage. The nodal network generator 108 can additionally identify data about such operations, such as tools, equipment, parts, time, etc., of the operations. The nodal network generator 108 can generate a node for each operation and other type of data. The nodal network generator 108 can identify the operation of the nodal network data structure to attach the operations to and link nodes representing the operations to the identified operation, thus generating an updated nodal network data structure representing an updated process of repairing the vehicle 138 including repairing the additional damage of the vehicle.

The user interface generator 112 can input the updated graph data structure into the large language model 106. The user interface generator 112 can execute the large language model 106 based on the input. In doing so, the user interface generator 112 may cause the large language model 106 to generate a second visual representation of the updated graph data structure. The user interface generator 112 can generate a user interface with the second visual representation of the updated graph data structure and transmit the user interface to the client device 134. The client device 134 can present the user interface to the technician, and the technician may follow the repair process depicted on the user interface.

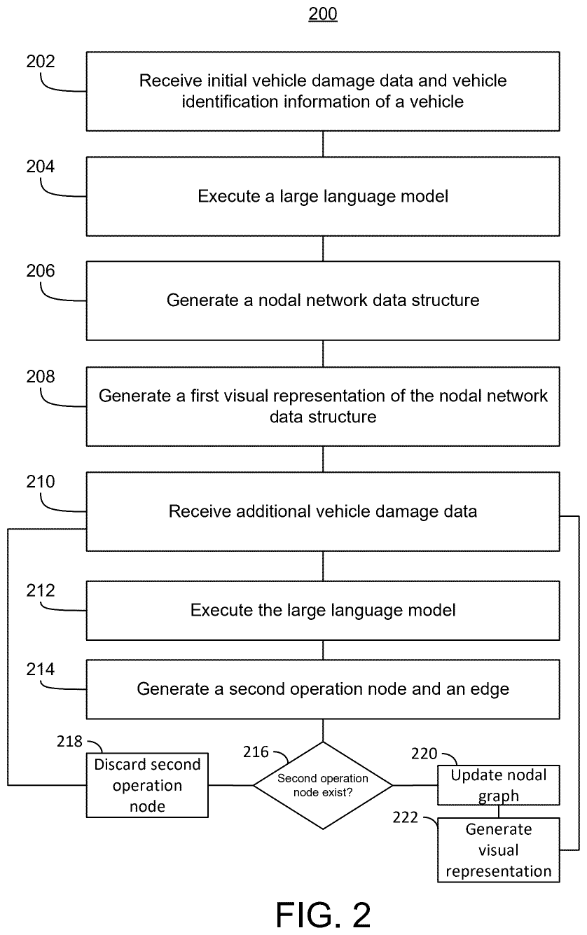

FIG. 2 is an illustration of an example method 200 of synchronizing a nodal network data structure, in accordance with implementations. The method 200 can be performed by one or more systems or components depicted in FIG. 1, or FIG. 10, including, for example, a data processing system.

At ACT 202, the data processing system can receive initial vehicle damage data and vehicle identification information (e.g., VIN, make, year, model, etc.) of a vehicle. The initial vehicle damage data can include identifications of the parts of the vehicle that are damaged or the locations of the vehicle that are damaged (e.g., damage location information). The data processing system can receive the initial vehicle damage data and the vehicle identification information from a client device. For example, a technician can provide an input into a user interface being presented at the user interface that includes the initial vehicle damage data and the vehicle identification information. The client device can transmit the input data to the data processing system.

At ACT 204, the data processing system can execute a large language model. The data processing system can execute the large language model using the input initial vehicle damage data and vehicle identification information as input. The execution can cause the large language model to perform RAG techniques to retrieve repair records or chunks of vehicle data from a RAG database (e.g., a vector database). In doing so, the large language model can retrieve repair records or chunks that are relevant to repairing or resolving the parts or location of the vehicle specific to the vehicle identification information that are damaged as indicated in the initial vehicle damage data.

At ACT 206, the data processing system can generate a nodal network data structure. For example, the data processing system can process the retrieved repair records or chunks to identify operations to perform to repair the vehicle damage. The data processing system can do so using the large language model or a different large language model. In some cases, the data processing system can do so using a plurality of agents that are configured or trained to operate as a fleet or cohort to generate the nodal network data structure. The data processing system can additionally include nodes indicating data about the operations represented by nodes in the nodal network data structure, such as by including nodes for equipment (e.g., parts or tools) to use to perform the operation or metadata about the operations, such as the time the operations will take to complete. The data processing system can link (e.g., via edges) the operation nodes together in sequence to indicate an order in which to perform or complete the operations. The data processing system can generate nodes for the ancillary data of the operations and link such nodes to the respective operation nodes in the nodal network data structure.

At ACT 208, the data processing system can generate a first visual representation of the nodal network data structure. The data processing system can generate the first visual representation of the nodal network data structure using the large language model or a different large language model. The data processing system can do so by inputting the nodal network data structure, or data extracted from the nodal network data structure, into the large language model with instructions to generate a visual representation of the nodal network data structure, such as in a list or as instructions for indicating a step-by-step process of how to repair the indicated damage to the vehicle. The data processing system can execute the nodal network data structure based on the input to cause the large language model to generate the requested visual representation of the nodal network data structure. The data processing system can transmit the requested visual representation of the nodal network data structure to the client device from which the data processing system received the initial vehicle damage data and vehicle identification information of the damaged vehicle. The client device can present the visual representation on a display. A technician can view the visual representation and follow the step-by-step instructions to repair the damage to the vehicle.

At ACT 210, the data processing system can receive additional vehicle damage data. The additional vehicle damage data can indicate an additional damaged part, additional damage information about the previously identified damaged part, or an additional location of the vehicle that is damaged. The data processing system can receive the additional vehicle damage data from the client device. The data processing system can receive the additional vehicle damage data when the technician repairing the vehicle identifies new damage during the repair process and provides an input indicating the identified new damage to the client device, which may then transmit the input additional damage information to the data processing system.

At ACT 212, the data processing system can execute the large language model. The data processing system can execute the large language model using the additional vehicle damage data or the vehicle identification information of the vehicle as input. In doing so, the data processing system can cause the large language model to retrieve further repair records or chunks from the RAG database that are relevant to repairing the damage identified in the additional damage information.

At ACT 214, the data processing system can generate an operation node (e.g., a second operation node) in the nodal network data structure. The data processing system can do so, for example, by processing the retrieved repair records or chunks using a large language model or a natural language processing protocol to determine an operation to resolve the newly identified damage to the vehicle. The data processing system can identify a node of the nodal network data structure in which to connect the newly generated operation node, such based on a user input at the client device or based on the context of the operation node matching or having a highest similarity to the identified node. The data processing system can generate an edge between the two nodes.

At ACT 216, the data processing system can determine whether the operation for the generated operation node is already represented in another operation node of the nodal network data structure. The data processing system can do so, for example, by identifying the language or context of the operation of the new operation node and comparing the language or context with the language or context of the other operation nodes within the nodal network data structure. Responsive to determining a match or a match above a threshold, the data processing system can determine the operation already exists within the nodal network data structure (e.g., the process represented by the nodal network data structure would have already resolved the new damage). Responsive to the determination, at ACT 218, the data processing system can discard (e.g., from memory or the nodal network data structure) the newly generated operation node, or otherwise omit the newly generated node from inclusion in the nodal network data structure. The data processing system can generate an alert at the client device indicating now new instructions or operations are needed to repair the vehicle.

However, responsive to determining that there is not a match, at ACT 220, the data processing system can update the nodal network data structure. The data processing system can update the nodal network data structure by including the newly generated node in the nodal network data structure with any other nodes that are linked to the node.

At ACT 222, the data processing system can generate a second visual representation of the nodal network data structure. The data processing system can generate the second visual representation of the nodal network data structure using the large language model or a different large language model. The data processing system can do so by inputting the updated nodal network data structure, or data extracted from the updated nodal network data structure, into the large language model with instructions to generate a visual representation of the nodal network data structure, such as in list for or as instructions for indicating a step-by-step process of how to repair the indicated damage to the vehicle. The data processing system can execute the nodal network data structure based on the input to cause the large language model to generate the updated visual representation of the nodal network data structure. The data processing system can transmit the updated visual representation of the nodal network data structure to the client device from which the data processing system received the additional vehicle damage data. The client device can present the updated visual representation on a display. A technician can view the updated visual representation and follow the step-by-step instructions to repair the damage to the vehicle.

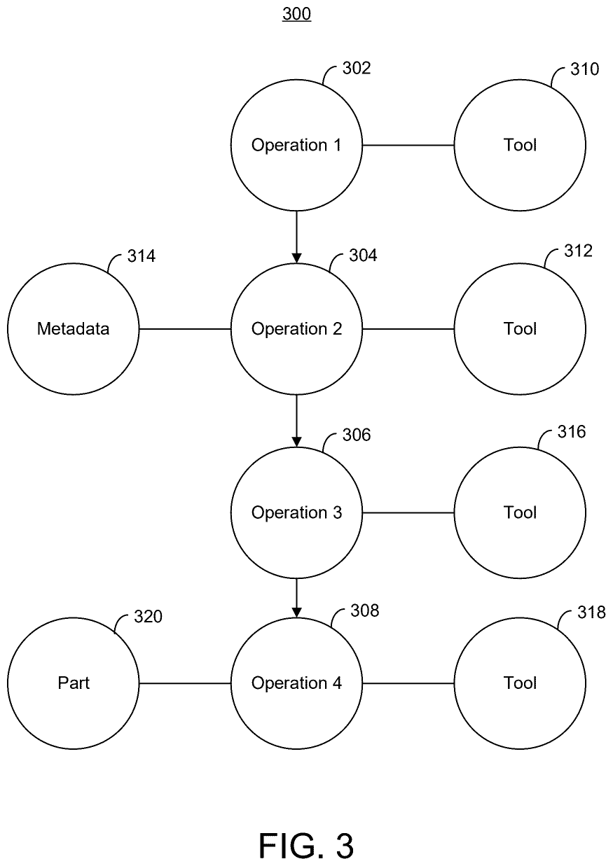

FIG. 3 is an illustration of a nodal network data structure 300, in accordance with implementations. The nodal network data structure 300 can be generated by one or more systems or components depicted in FIG. 1, or FIG. 10, including, for example, a data processing system.

The data processing system can generate the nodal network data structure 300 in response to receiving initial vehicle damage data and vehicle identification of a vehicle from a client device. The nodal network data structure 300 can represent a process for repairing the damaged vehicle. For example, the nodal network data structure 300 can include operation nodes 302-308 that each represent or correspond to different operations for repairing the vehicle. The operation nodes 302 can be connected in sequence to identify an order in which to perform the operations. For example, to repair a broken bumper, the operation corresponding to the operation node 302 may be to remove the broken bumper from the vehicle, the operation corresponding to the operation node 304 may be to inspect the mounting points and support structure, the operation corresponding to the operation 306 may be to test the fit of a new bumper, and the operation corresponding to the operation node 308 may be to install and connect the new bumper to the vehicle. The tools needed to perform the operations may be represented by tool nodes 310-318, which may be connected with the nodes representing the operations for which the tools are to be used. The operation nodes 302-308 may additionally or instead be connected with metadata nodes indicating metadata about the operations of the operation nodes, such as a metadata node 314 which may indicate an expected amount of time operation two will take. The operation nodes 302-308 may additionally or instead be connected with part nodes indicating vehicle parts that may be needed to perform the operation, such as a part node 320 which may indicate a vehicle part (e.g., a new bumper) that may be needed to perform operation four. Although not separately labeled, the nodes of the nodal network data structure 300 may be connected by edges indicating the nodes that correspond to each other.

Nodal network data structures, such as the nodal network data structure 300 may be used by a large language model to generate visual representations of a step-by-step process for repairing vehicles. By formatting the data for the repair process in this way, the system can substantially reduce the amount of data the large language models need to process to generate a visual representation of a repair process compared with systems that rely solely on a RAG retrieval technique. In doing so, the system can substantially reduce hallucinations and token usage in the large language models, which can be prone to generate inaccurate steps when a large amount of data is provided as input, such as because they may not give adequate weight to “data in the middle of the input” and focus their learned weights and parameters on the text at the beginning and the end of the input. The nodal network data structure 300 substantially reduces the size of the input and provides the data in a structured format to increase the accuracy of the output by the large language models.

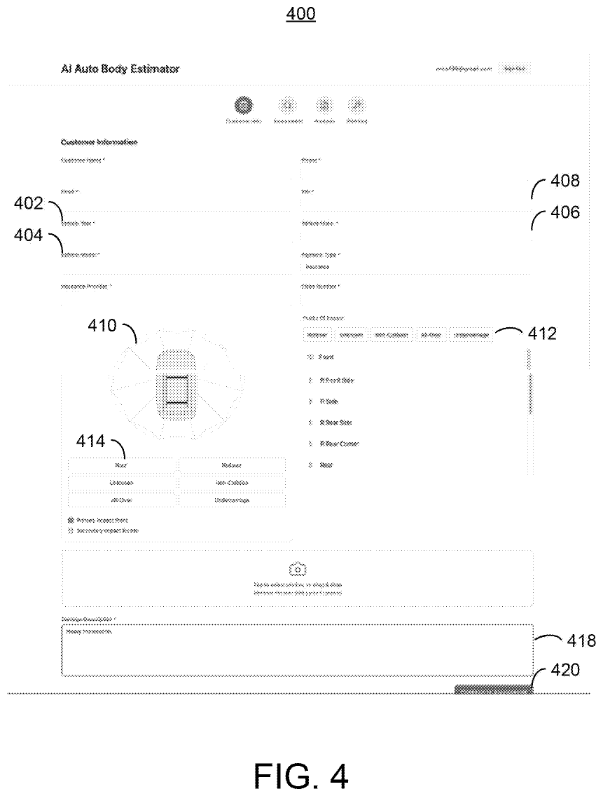

FIG. 4 is an illustration of a graphical user interface 400 for inputting vehicle damage information, in accordance with implementations. The graphical user interface 400 can be generated by one or more systems or components depicted in FIG. 1 or FIG. 10, including, for example, a data processing system.

The data processing system can generate the graphical user interface 400 for display on a platform hosted by the data processing system. The graphical user interface 400 can include forms into which a user (e.g., a technician or an estimator) can input vehicle damage information and/or vehicle identification information that the data processing system can use to generate nodal network data structure representing a repair plan to repair the damage. The graphical user interface 400 can include forms into which a user can input information about a damaged vehicle, such as a vehicle year form 402, a vehicle model form 404, a vehicle name form 406, or vehicle identification number form 408.

The graphical user interface 400 can additionally or instead include areas into which the user can input information identifying location information (e.g., specific points on the vehicle or specific parts of the vehicle) that are damaged. The areas can include a pie chart 410 and point identifier portion 412. The pie chart 410 can depict a vehicle on top of a pie chart segmented into a plurality (e.g., ten) portions. Each slice can correspond to a particular area of the vehicle being assessed. A user can select one or more of the slices of the pie chart 410 and select an option from the options 414 further indicating the location on the vehicle in which there is damage. The point identifier portion 412 can be used to provide similar information to the pie chart 410, but provides the user with text options to indicate the locations of the damage instead of the visual slices provided by the pie chart 410.

The graphical user interface 400 can additionally or instead include a photo portion and a damage description portion. A user can upload an image of the damage to the vehicle by selecting the photo portion. A user can add or provide a description of the damage in the damage description portion 418. Responsive to filling out the forms or portions of the graphical user interface 400 to describe the damage to the vehicle, the user can select a submit button 420 to cause the client device displaying the graphical user interface 400 to the data processing system for further processing (e.g., to generate a nodal network data structure and visual representation of a process for repairing the damage to the vehicle indicating the input into the graphical user interface 400).

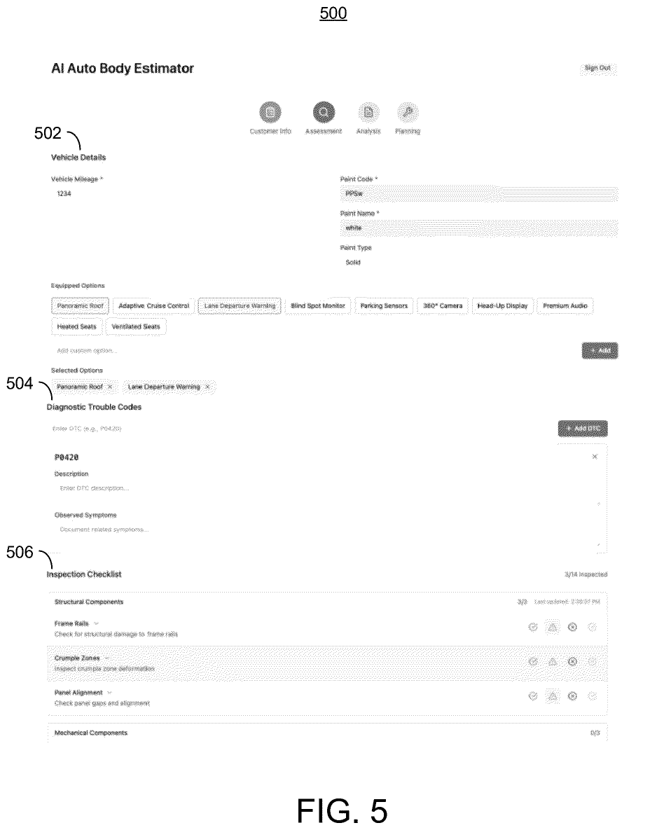

FIG. 5 is an illustration of a graphical user interface 500 for inputting vehicle damage information, in accordance with implementations. The graphical user interface 500 can be generated by one or more systems or components depicted in FIG. 1 or FIG. 10, including, for example, a data processing system.

The data processing system can generate the graphical user interface 500 responsive to receiving selection of the submit button 420 from the user interface 400, for example. The graphical user interface 500 may be to provide further information about the vehicle for which the data processing system is generating a visual representation of a repair process. For example, the graphical user interface 500 can include vehicle details forms 502, diagnostic trouble codes forms 504, and an inspection checklist 506. The vehicle details forms 502 can include forms into which a user can provide information about the vehicle, such as vehicle mileage, a paint code a paint name, or a paint type. The vehicle details forms 502 can additionally or instead include selectable buttons that the user can select options that the car has. The diagnostic trouble codes forms 504 can include forms into which a user can provide diagnostic trouble codes that the user identified from the vehicle with a description and/or symptoms of such diagnostic trouble codes.

The inspection checklist 506 can include a list of components, areas, or parts of the vehicle to inspect. The data processing system can include the same checklist on the graphical user interface 500 for each instance or can dynamically select the list or parts of the list based on the data that is input into the graphical user interface 400. The inspection checklist 506 can include lists of components, such as for structural components and mechanical components to be checked. A user, such as a technician, can view the components and select options to indicate whether the check of the components has been performed.

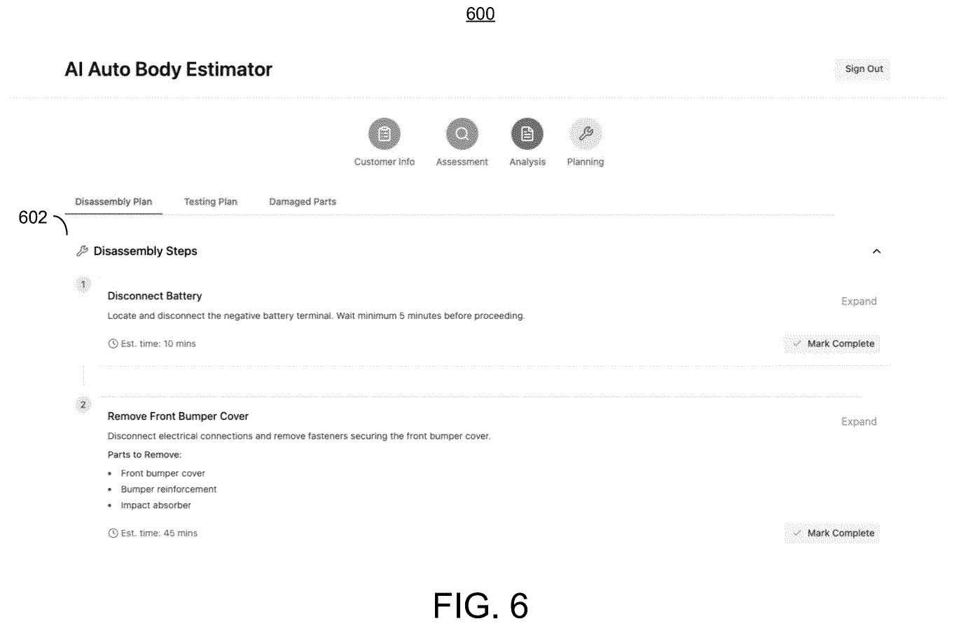

FIG. 6 is an illustration of a graphical user interface 600 presenting a visual representation of a nodal network data structure, in accordance with implementations. The graphical user interface 600 can be generated by one or more systems or components depicted in FIG. 1 or FIG. 10, including, for example, a data processing system.

The data processing system can generate the graphical user interface 600 responsive to receiving an input into the graphical user interface 500 submitting the input data of the graphical user interface 500. For example, the data processing system can process the data that was input into the graphical user interfaces 400 and 500 using the systems and methods described herein to generate a nodal network data structure representing a repair plan for repairing the vehicle subject to the inputs. The nodal network data structure can include operations relevant to dissembling the vehicle to check for further damage. The data processing system can generate a visual representation of such operations by generating a list of the operations with components that are needed or relevant for performing the operations and metadata about the operations, such as the amount of time each operation would take. The data processing system can depict the visual representation in the disassembly steps 602 of the graphical user interface 600.

In some cases, in performing the disassembly, the user can identify further damage to the vehicle that the user did not previously identify. In doing so, the user can provide an input identifying the further damage into the graphical user interface 600. The data processing system can receive the input and update the nodal network data structure according to the additional vehicle damage data.

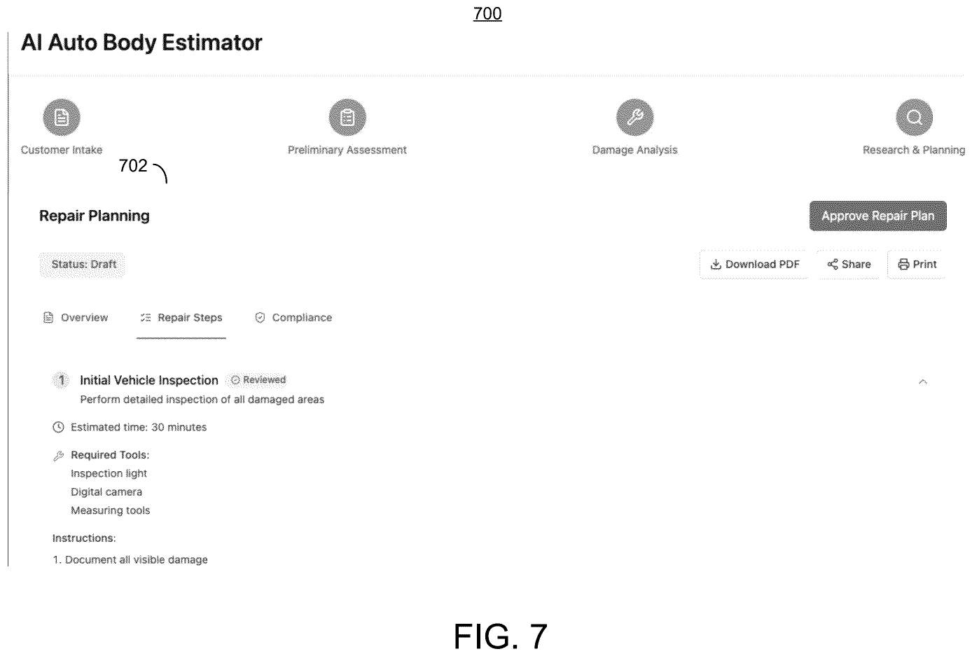

FIG. 7 is an illustration of a graphical user interface 700 presenting a visual representation of a nodal network data structure, in accordance with implementations. The graphical user interface 700 can be generated by one or more systems or components depicted in FIG. 1 or FIG. 10, including, for example, a data processing system.

The data processing system can generate the graphical user interface 700 responsive to receiving an input into the graphical user interface 600 submitting the additional vehicle data or responsive to an input indicating completion of the disassembly phase of the repair plan. For example, the data processing system can process any additional vehicle damage data to update the nodal network data structure. The data processing system can generate a visual representation of the operations represented in the nodal network data structure after the disassembly operations. In some cases, the nodal network data structure may only include operations after the disassembly operations, and the disassembly operations may be determined automatically or may be static (e.g., the same each time). The data processing system may display the visual representation on the graphical user interface 700 as visual representation 702.

As illustrated, the visual representation 702 can include one or more operations for repairing the vehicle including various data about the operations. For instance, the operations can include an estimated time (which may be determined based on a metadata node linked with an operation node of the operation), required tools (which may be determined based on tools node linked with an operation node of the operation), or instructions (which may be determined based on tools node linked with an operation node of the operation). The visual representation 702 may include any number of operations with corresponding data in list form. A technician can view the visual representation and follow the operations outlined in the visual representation 702 to repair the vehicle, in some cases inputting newly identified damage to the vehicle on the way to cause the data processing system to dynamically update the visual representation 702.

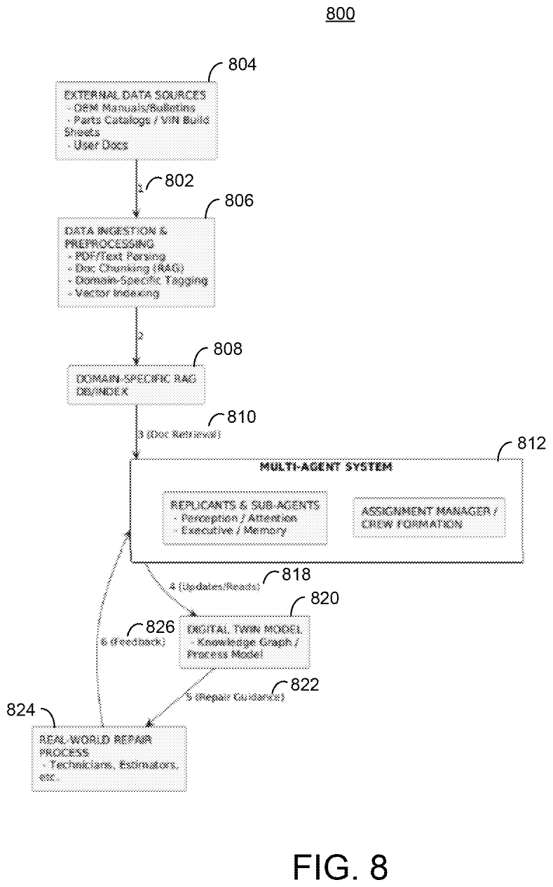

FIG. 8 is an illustration of an example sequence 800 of a multi-agent system for updating a nodal network data structure, in accordance with implementations. The sequence 800 can be performed by one or more systems or components depicted in FIG. 1, or FIG. 10, including, for example, a data processing system.

At ACT 802, the data processing system can retrieve or receive repair records from one or more external data sources 804. At ACT 806, the data processing system can ingest and perform preprocessing of the retrieved data by parsing the data and chunking the parsed data based on the domain or content of the data. The data processing system can perform domain-specific (e.g., vehicle part-specific) tagging or vector indexing. In doing so, the data processing system can generate a domain-specific RAG database or index 808. At ACT 810, the data processing system can retrieve relevant repair records or chunks from the RAG database or index 808. The data processing system can do so in response to receiving an input of vehicle damage data or vehicle identification information.

The data processing system can retrieve the repair records or chunks using a multi-agent system 812. The multi-agent system 812 can include can replicant or sub-agents, such as a replicant that includes the sub-agents of perception or attention or a replicant that includes the sub-agents of executive or memory. The multi-agent system 812 can additionally or instead include an assignment manager or formation agent or replication. The data processing system can execute the multi-agent system 812 to generate, at ACT 818, a nodal network data structure 820 representing a repair process for repairing the damage to the vehicle.

At ACT 822, the data processing system can generate a visual representation of the nodal network data structure 820 and present the nodal network data structure 820 at a user interface of the client device that submitted the initial vehicle damage information. A technician or estimator can perform a real-world repair process 824 to repair the vehicle. In doing so, the technician or estimator can identify new damage to the vehicle and provide feedback 826 identifying the new damage to the multi-agent system 812. The multi-agent system 812 can identify the feedback and update the nodal network data structure 820 according to the feedback. The multi-agent system 812 can generate a new visual representation of the repair plan based on the updated nodal network data structure. The multi-agent system 812 can present the new visual representation of the repair plan at the client device to the technician, which can then use the new visual representation to repair the vehicle. The multi-agent system 812 and technician can repeat this process any number of times until the technician repairs the vehicle or provides input to the multi-agent system 812 indicating the repair is complete.

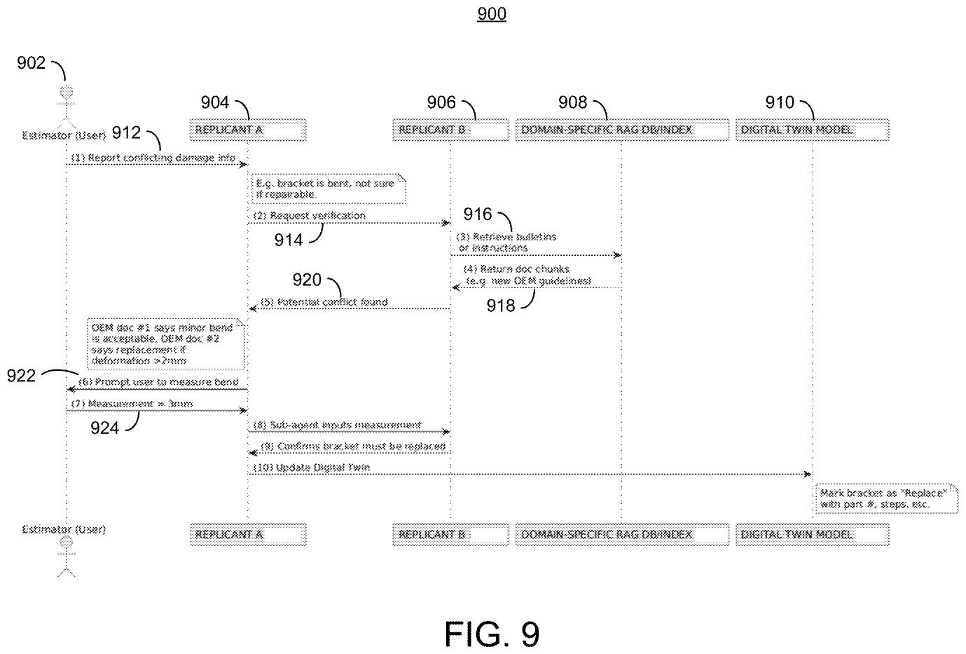

FIG. 9 is an illustration of an example sequence 900 of resolving a conflict in updating a nodal network data structure, in accordance with implementations. The sequence 900 can be performed by one or more systems or components depicted in FIG. 1, or FIG. 10, including, for example, a data processing system. In one example, ACTs of the sequence 900 can be performed by or involve a user 902 (e.g., an estimator or a technician) and components of the data processing system, such as a replicant 904, a replicant 906, a RAG database 908, and a nodal network data structure 910.

At ACT 912, the user 902 can provide vehicle damage information to the replicant 904. The vehicle damage information can be an indication that a bracket is bent. At ACT 914, the replicant 904 can request verification from the replicant 906. At ACT 916, the replicant 906 can query the RAG database 908 for relevant repair records to the vehicle damage information. At ACT 918, the RAG database 908 can return the relevant repair records in a chunk to the replicant 906. At ACT 920, the replicant 904 or the replicant 906 can identify a potential conflict. The conflict can be, for example, that one repair record indicates that a minor bend in the bracket is acceptable while another repair record indicates that a replacement record is needed if the deformation in the bracket exceeds two millimeters.

At ACT 922, the replicant 904 can prompt the user 902 to measure the bend in the bracket. At ACT 924, the user can provide an input indicating the bend is three millimeters to the replicant 904. The replicant 904 can provide (e.g., via a message board) the input measurement to the replicant 906. The replicant 906 can confirm the bracket needs to be repaired based on the measurement of three millimeters exceeding the millimeter threshold of one of the repair documents. The replicant 904 can update the nodal network data structure to add a node for an operation to repair or replace the bent bracket. The replicant 904 can include nodes with other information about the repair or replacement in the update, such as a part number of the replacement bracket, steps for replacing the bracket, an expected time it will take to replace the bracket, etc.

The data processing system can be built on a deterministic framework that integrates three core components: an artificial intelligence-powered backend, a user interface, and a nodal network data structure. The artificial intelligence-powered backend can be powered by a neuropsychology-based multi-agent AI framework and mimic human cognitive functions such as perception, attention, and executive reasoning. This framework can analyze structured data from diverse sources—OEM documentation, diagnostic outputs, and damage photos—to construct a dynamic, repeatable repair model tailored to each unique case. The backend can operate on a cloud-based infrastructure, ensuring scalability, real-time data processing, and seamless updates.

The user interface, accessible via web and mobile platforms, can provide technicians or estimators with intuitive tools to input data, review outputs, and refine repair plans. Through interactive visualizations and automated prompts, the user interface can guide users in validating outputs and provides clear, evidence-based justifications for insurers and customers. The nodal network data structure can be a deterministic representation of the repair process that captures the sequence of required parts, materials, labor, and tools. This model can ensure consistency and compliance across all outputs, including estimates and technician instructions.

The data processing system can perform different assignments to update and maintain nodal network data structures. For example, for each new vehicle, the data processing system can execute a foundational replicant to obtain the VIN of the new vehicle and retrieve the vehicle's build sheet. The foundational replicant can correlate available bulletins, part catalogs, and OEM manuals specific to that VIN range. The sub-agents of the foundational replicant sub-agents can generate a disassembly plan to expose potential hidden damage. If new damage is revealed, the foundational replicant triggers sub-assignments for deeper analysis (e.g., specialized calibrations, structural checks). If partial repairs or new steps are identified by other crews (e.g., “Sublet Coordination” finds a specialized process for aluminum welding), the foundational replicant can reconcile the new data with existing records in the nodal network data structure. For example, a seat belt mounting point can be flagged as suspect during disassembly. The foundational replicant can retrieve occupant-restraint bulletins from the OEM documents (e.g., via RAG retrieval techniques), verify recommended torque specs, and update the nodal network data structure's procedural node for seat belt mounting.

Other examples of assignments can involve the data processing system extending beyond mere document lookup to actively guide and manage repairs. One example is estimate creation. In doing so, the data processing system can compile all relevant repair operations from the nodal network data structure into a standard estimate format, referencing recognized labor/time data from third-party sources. A specialized replicant (a “cost mapping sub-agent”) can facilitate each recommended procedure being properly matched to an operation node or labor node. In doing so, the replicant can generate an estimate that data about each operation and data about the operations. In another example, the data processing system can use the nodal network data structure for damage assessment. Whenever new damage is found mid-repair, an assignment can be triggered to fully evaluate and classify it the new damage. The data processing system can execute a crew of replicants including a researcher replicant (which can be configured to pull bulletins on structural damage), a verification replicant (which can check prior disassembly steps), and a manager replicant (which can update timelines and part availability). The crew of replicants can feed the results immediately into the nodal network data structure. An assignment may be an estimate audit. In performing this assignment, the data processing system can perform cross-checks of a third-party or human-created estimate against the nodal network data structure representing the process. If the nodal network data structure representing the process includes steps not in the estimate (e.g., corrosion protection procedures), the audit replicant can flag or generate an alert indicating the discrepancy. An assignment may be sublet coordination. In performing this assignment, for specialized tasks (e.g., ADAS sensor calibration), the data processing system can facilitate scheduling aligns with the evolving repair plan. The nodal network data structure can be updated to reflect when sublet tasks must occur (e.g., “sensor calibration after body reassembly, before final quality checks”).

In an example, a user can input a VIN of a vehicle being prepared. The foundational replicant can enrich the VIN with repair records from remote data sources (e.g., build-sheet data from OEM records. A perception sub-agent can index relevant bulletins on occupant-restraint systems. The data processing system can generate a damage assessment assignment. A crew (e.g., researcher, verification, and manager replicants) can verify that the occupant-restraint bulletins require seat belt mounting points to be checked. Upon partial disassembly, the user can discover that the seat belt mounting bracket is bent. A conflict can arise because a prior bulletin indicated it might be salvageable if deformation was minimal.

During conflict resolution, the verification replicant can query the vector database for more recent bulletins. In doing so, the verification replicant can identify an updated bulletin stating that any bracket deformation over 2 mm requires replacement. The user can measure a ~3 mm deformation, confirming replacement is necessary. One of the replicants can update the seat belt bracket node to “Replace,” linking to the updated OEM bulletin. The nodal network data structure can now reflect a new parts order requirement, new steps for bracket replacement, and associated torque specifications. An estimate creation assignment can be created automatically. A specialized replicant references recognized time/labor data for bracket removal and replacement to ensure it is included in the estimate. This process can ensure no steps are missed, the bracket can be correctly replaced, and the shop can fully justify the additional labor in the final bill. The nodal network data structure can remain an auditable record of all decisions and references.

By implementing the systems and methods described herein, the data processing system can seamlessly guide users through four operational phases: intake, preliminary assessment, disassembly and damage analysis, and execution. Users can interact with the data processing system through an intuitive interface, inputting details such as vehicle information (VIN, mileage, accident specifics), damage photos, and diagnostic codes. Upon receiving this data, the data processing system's multi-agent system—modeled on neuropsychological principles—can process the inputs using specialized agents for executive function, perception, and attention. These agents can retrieve and analyze relevant data from multiple sources, including OEM guidelines and diagnostic outputs, constructing a detailed repair model.

During the preliminary assessment, the data processing system can prompt users with targeted safety checks and disassembly steps, such as inspecting seatbelt mounts or removing damaged panels. As users confirm findings (e.g., “fender dented”), the data processing system can update the repair model in real time, capturing all parts, tools, and labor needed for the repair. The disassembly and damage analysis phase can further refine the model, dynamically integrating additional findings, such as inspection results and technician feedback. Throughout, users can be prompted to review and approve outputs, ensuring transparency and control.

The repair model can then be translated into actionable outputs, including detailed estimates, parts orders, and technician instructions. These outputs can be delivered via the user interface, enabling technicians to follow step-by-step repair guides with real-time updates if new damage is discovered. The data processing system's planned integration with shop management platforms will enhance interoperability, facilitating seamless adoption across diverse repair environments.

By automating complex reasoning tasks and creating a comprehensive repair model, the data processing system can transform collision repair planning, offering faster, more accurate outputs while maintaining user oversight and accountability.

A few examples of advantages of the framework include (1) deterministic precision: the data processing system can frame the repair process as a deterministic problem, facilitating precise, repeatable, and verifiable outputs tailored to each repair instance, which can offer the advantages of eliminating variability in outputs, ensuring compliance, accuracy, and transparency, that is unmatched by heuristic-driven tools; (2) repair process digital twin: a dynamic, comprehensive digital twin captures every aspect of the repair process, providing a unified source of truth, which can offer the advantages of facilitating consistency across estimates, parts orders, and repair instructions, reducing errors and manual effort; artificial intelligence digital twin solver: the system automates reasoning across multiple data sources, such as OEM guidelines and diagnostic outputs, to synthesize actionable outputs, which offers the advantages of reducing the cognitive load on users, streamlining decision-making and improving efficiency; (4) a neuropsychology-based multi-agent framework: mimics human cognitive processes to handle complex problem-solving with systematic precision, which offers the advantages of providing a unique, human-like reasoning capability, enabling the system to manage intricate repair scenarios; (5) end-to-end automation: automates the repair planning workflow, from intake to execution, which offers the advantages of speeding up workflows and facilitating seamless repair planning; (6) immutable repair record: creates a transparent, verifiable audit trail for all repair activities, which offers the advantages of enhancing accountability and building trust among customers, insurers, and regulators; (7) proactive error prevention: focuses on preventing errors at the planning stage rather than catching them later, which offers the advantages of improving repair accuracy, reducing rework, and enhancing customer satisfaction; and (8) scalability and future integration: modular architecture allows integration with shop management tools, diagnostic systems, and other platforms, which offers the advantages of a dynamic solution for evolving repair industry needs, facilitating seamless adoption f new technologies.

In an example, a technician using a client device can input initial vehicle damage data for a 2023 sedan, indicating damage location as “left rear quarter panel impact damage” along with the vehicle's VIN number, make, model, and year. The data processing system can execute a large language model to process the damage information and vehicle data, querying a RAG database containing historical repair records, OEM repair procedures, and technical documentation. The data processing system can retrieve repair records related to similar quarter panel damage patterns on comparable vehicle models.

Based on these retrieved records, the data processing system can generate a nodal network data structure where the root operation node represents the initial quarter panel damage assessment, with connected operation nodes representing tasks such as “Remove Tail Lamp Assembly,” “Remove Quarter Panel Trim,” and “Remove Damaged Quarter Panel Section.” Equipment nodes linked to these operations include required tools such as pneumatic cutting tools, welding equipment, and panel removal tools, with each node containing metadata including estimated time, cost, or skill requirements. The data processing system can generate a first visual representation showing these operations as a sequential list of repair instructions, where each instruction includes associated time estimates, required tools, prerequisites, and completion status. This list is displayed on the client device's screen for the technician to follow.

During the quarter panel removal process, the technician may discover hidden structural damage to the rear frame rail that was not visible during the initial inspection. This additional vehicle damage data can be input through the client device. The data processing system can process this new information through the large language model, querying the RAG database for relevant repair procedures specific to the vehicle's frame rail repair requirements. Based on these retrieved records, the data processing system can generate new operation nodes for “Frame Rail Inspection,” “Frame Rail Repair,” and “Frame Rail Reinforcement Installation” with associated equipment nodes for frame straightening equipment and structural adhesive application tools.

The data processing system can establish edges connecting these new nodes to the “Remove Damaged Quarter Panel Section” node while updating the dependency relationships and repair sequence. The data processing system can then generate an updated visual representation showing the revised list of instructions, now including the additional steps for frame rail repair along with their associated time estimates, required tools, and dependencies. This updated repair plan can be displayed on the client device's interface, allowing real-time collaboration between technicians and estimators.

FIG. 10 is a block diagram of an example computer system 1000. The computer system or computing device 1000 can include or be used to implement the system 100 or its components such as the data processing system 102. The computing system 1000 includes a bus 1005 or other communication component for communicating information and a processor 1010 or processing circuit coupled to the bus 1005 for processing information. The computing system 1000 can also include one or more processors 1010 or processing circuits coupled to the bus for processing information. The computing system 1000 also includes main memory 1015, such as a random access memory (RAM) or other dynamic storage device, coupled to the bus 1005 for storing information, and instructions to be executed by the processor 1010. The main memory 1015 can be or include the data repository 126. The main memory 1015 can also be used for storing position information, temporary variables, or other intermediate information during execution of instructions by the processor 1010. The computing system 1000 may further include a read only memory (ROM) 1020 or other static storage device coupled to the bus 1005 for storing static information and instructions for the processor 1010. A storage device 1025, such as a solid state device, magnetic disk or optical disk, can be coupled to the bus 1005 to persistently store information and instructions. The storage device 1025 can include or be part of the data repository 126.

The computing system 1000 may be coupled via the bus 1005 to a display 1035, such as a liquid crystal display, or active matrix display, for displaying information to a user. An input device 1030, such as a keyboard including alphanumeric and other keys, may be coupled to the bus 1005 for communicating information and command selections to the processor 1010. The input device 1030 can include a touch screen display 1035. The input device 1030 can also include a cursor control, such as a mouse, a trackball, or cursor direction keys, for communicating direction information and command selections to the processor 1010 and for controlling cursor movement on the display 1035. The display 1035 can be part of the data processing system 102, the client device 134 or other component of FIG. 1, for example.

The processes, systems and methods described herein can be implemented by the computing system 1000 in response to the processor 1010 executing an arrangement of instructions contained in main memory 1015. Such instructions can be read into main memory 1015 from another computer-readable medium, such as the storage device 1025. Execution of the arrangement of instructions contained in main memory 1015 causes the computing system 1000 to perform the illustrative processes described herein. One or more processors in a multi-processing arrangement may also be employed to execute the instructions contained in main memory 1015. Hard-wired circuitry can be used in place of or in combination with software instructions together with the systems and methods described herein. Systems and methods described herein are not limited to any specific combination of hardware circuitry and software.

Although an example computing system has been described in FIG. 10, the subject matter including the operations described in this specification can be implemented in other types of digital electronic circuitry, or in computer software, firmware, or hardware, including the structures disclosed in this specification and their structural equivalents, or in combinations of one or more of them.

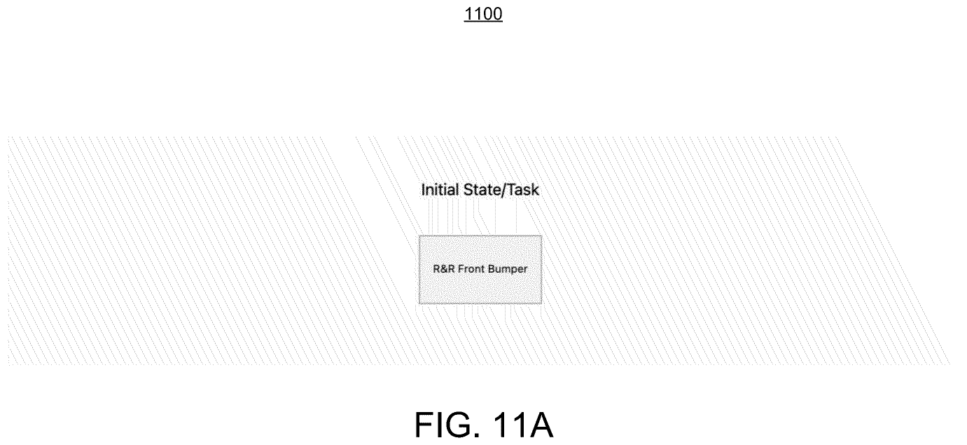

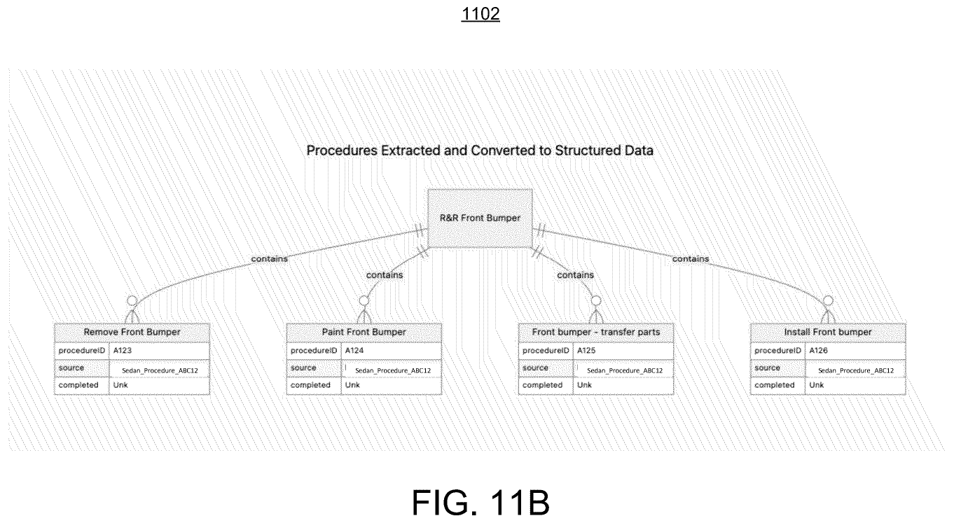

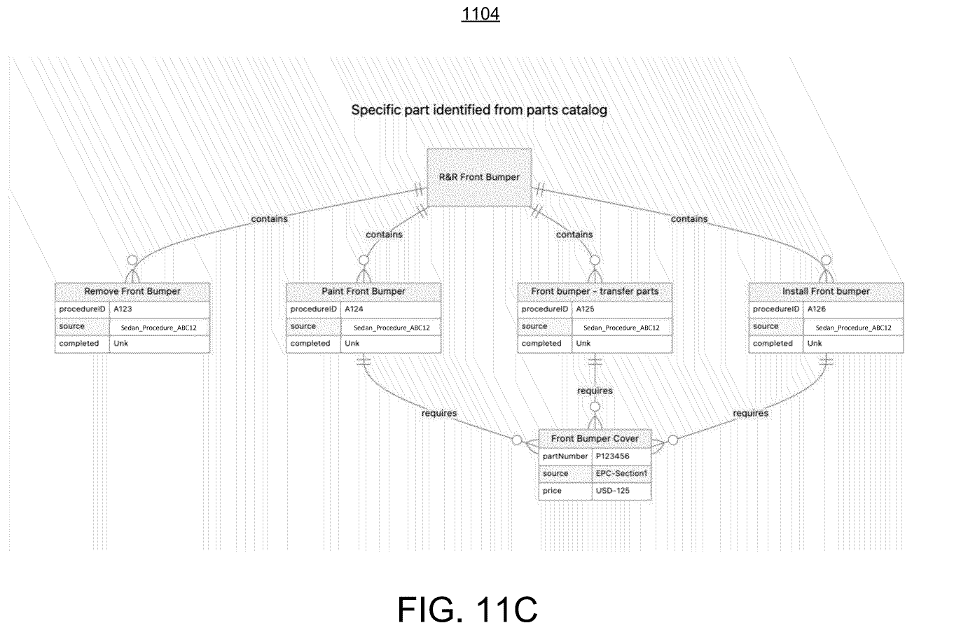

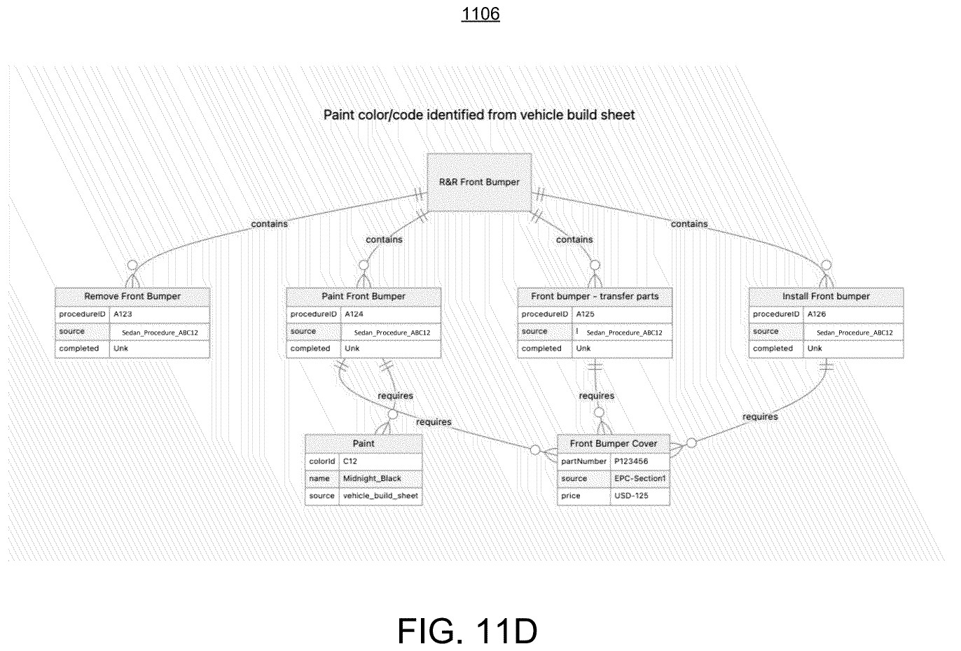

FIGS. 11A-11D illustrate an example sequence of updating a nodal network data structure, in accordance with implementations. The sequence can be performed by one or more systems or components depicted in FIG. 1, or FIG. 10, including, for example, a data processing system. The sequence can be used to generate a nodal network data structure by recursively retrieving data and updating the nodal network data structure. In some cases, the data processing system can perform the sequence when performing ACT 206 and/or ACT 220 of the method 200, described with respect to FIG. 2.

In brief overview, when performing the sequence, the data processing system can perform the following operations. The data processing system can receive a task. The data processing system can identify one or more documents (e.g., electronic documents) from a database or data repository (e.g., a vector database). The data processing system can determine relevancy scores for parts or all of each of the documents to the task. The data processing system can extract and process the data of the documents into structured data of different data structures. The data structures can be nodes of a nodal network data structure. The nodes or data structures can represent steps to perform or complete the task. The data processing system can generate data structures for sub-tasks or otherwise enrich the previously generated data structures for (a) adjacent procedures, (b) sub-steps (breakdown into smaller steps), (c) associated parts, (d) associated materials, (e) estimated labor times, etc. The data processing system can link the generated or updated data structures to the nodes of the nodal network data structure to generate or update the nodal network data structure.

At ACT 1100, the data processing system can receive a task. The task can be to replace the front bumper on a 2022 Sedan 3 series. The data processing system can receive the task in a request from a client device, for example. Responsive to receiving the task, the data processing system can query a database (e.g., the data repository 126) using the task, the language of the task, or other data regarding the task or the vehicle, as described herein, in the query. The data processing system may do so by generating an embedding from such data and identifying one or more documents that correspond to embeddings that are the most similar to the embedding generated for the request.

The data processing system can use a large language model or a semantic language model to review the retrieved documents. In doing so, the data processing system can generate a relevancy score for each of the retrieved documents or portions or segments of the retrieved documents (e.g., portions of the documents that the data processing system separately identified as corresponding to a particular topic or format different from the surrounding content, such as a table in a document full of text or text with a heading). In some cases, the data processing system can determine the relevancy score for a document as the similarity between the embedding generated for the task and an embedding generated for the document. The data processing system can compare the relevancy score to a threshold. The data processing system can determine to use the document to generate a nodal network data structure responsive to determining the relevancy score exceeds the threshold.

For instance, the data processing system can determine a relevancy score for a document titled “Sedan_Procedure_ABC12.” The data processing system can determine the relevancy score exceeds the threshold. Responsive to the determinations, the data processing system can determine the document is or may be relevant to a procedure for removing and replacing the front bumper of a Sedan.

At ACT 1102, the data processing system can process the content of the document into structured data. The data processing system can process the content of the document into structured data using one or more large language models. For instance, the data processing system can execute a large language model using the document as input to cause the large language model to output structured data regarding one or more procedures of the document. The procedures can be, for example, as follows:
A. Procedure 1
   i. Universal Procedure Id:0123
   ii. Universal procedure description: ‘Remove front bumper’
   iii. Source: Sedan Procedure ABC12—Remove and replace front fascia
   iv. Part Number: ?
   v. Tools Needed: ?
   vi. Completed: ?
b. Procedure 2
   i. Universal procedure id:0124
   ii. Universal procedure description: ‘Paint front bumper’
   iii. Source: Sedan Procedure ABC12—Remove and replace front fascia
   iv. Part Number: ?
   v. Tools Needed: ?
   vi. Completed: ?
c. Procedure 3
   i. Universal procedure id:0125
   ii. Universal procedure description: ‘Front bumper-transfer parts’
   iii. Source: Sedan Procedure ABC12—Remove and replace front fascia
   iv. Part Number: ?
   v. Tools Needed: ?
   vi. Completed: ?
d. Procedure 4
   i. Universal procedure id:0126
   ii. Universal procedure description: ‘Install Front bumper’
   iii. Source: Sedan Procedure ABC12—Remove and replace front fascia
   iv. Part Number: ?
   v. Tools Needed: ?
   vi. Completed: ?

The large language model can generate a separate data structure for each procedure. The large language model can do so according to a template, such as a template that includes field-value pairs for one or more, or a defined combination or permutation of, “universal procedure id,” “universal procedure description,” “source,” “part number,” “tools needed,” or “completed.” The large language model can identify data from the document that corresponds to each such field-value pair and insert the identified data in the fields of the relevant field-value pairs. For any field-value pairs for which the data processing system does not identify the relevant data, the large language model may insert a nonce value or leave the field blank.

The data processing system can include the generated data structures in a nodal network data structure, such as by linking each data structure with a data structure identifying the task (e.g., remove and repair the front bumper) with identifiers of the respectively linked data structure and/or an identification of the relationship (e.g., the task of removing and repairing a front bumper contains each of the respective procedures represented the generated data structures).

At ACTs 1104 and 1106, the data processing system can enrich the nodal network data structure. The data processing system can do so by querying the database or another document for further data that is relevant to each of the respective procedures represented in the nodal network data structure. For instance, the data processing system can use the large language model to identify another document based on the query or another query to the database that is relevant to generating the nodal network data structure. The document can be, for example, a parts catalog for the Sedan being repaired. The large language model can use a template that corresponds to part types. The template can include field-value pairs for one or more of, or a defined combination or permutation of, “part number,” “source,” “part number,” and “price.” The large language model can identify data from the document that corresponds to each such field-value pair and insert the identified data in the fields of the relevant field-value pairs. For any field-value pairs for which the data processing system does not identify the relevant data, the large language model may insert a nonce value or leave the field blank.

In some cases, the data processing system can determine to generate further nodes in the nodal network data structure using sub-tasks. For instance, for one or more of the procedures, the data processing system can generate or determine one or more sub-tasks. An example of such sub-tasks is as follows:
a. Procedure 1—Sub-task 1: “Is there any pre-work required before removing the front bumper?”
b. Procedure 1—Sub-task 2: “What tools are required to remove the front bumper?”
c. Procedure 2—Sub-task 1: “What is the paint color code for this vehicle?”
d. Procedure 3—Sub-task 1: “What parts are installed on the old bumper that need to be transferred to the new bumper?”
   The data processing system can determine such sub-tasks by processing or determining the context of the different procedures using the large language model, such as by analyzing the text from which the large language model generated the data structures for the respective procedures or by identifying the contents within the respective data structures. The data processing system can generate a separate data structure for each sub-task, such as by identifying one or more documents relevant to the sub-task (e.g., by performing another query into the database or one or more documents identified from the initial query). The large language model can use a template for each sub-task, which the large language model can identify based on the types of the respective sub-tasks (e.g., based on a mapping between templates and different types of sub-tasks). Examples of types of sub-tasks can be a part sub-task, a tool sub-task, an additional step sub-task, etc. The data processing system can extract data from the documents that are relevant to the respective data structures and insert the extracted data into the relevant fields of the data structures generated for the sub-tasks.

The data processing system can include the generated data structures for the sub-tasks in the nodal network data structure, such as by linking each data structure generated for a sub-task with a data structure identifying the procedure pertaining to the sub-task with identifiers of the respectively linked data structure and/or an identification of the relationship (e.g., the sub-tasks may be required to complete the procedures).

The data processing system can similarly generate a data structure for a paint color to use to paint the bumper or other portions of the vehicle. For instance, the data processing system can identify a vehicle build sheet based on a query for a sub-task of determining the paint color code for the vehicle. The data processing system can use a template to generate a data structure for paint color with the field-value pairs of “colorid,” “name,” and “source.” The data processing system can retrieve or extract the data for the data structure from the vehicle build sheet using the large language model and insert the data into the generated data structure. The large language model can link the generated data structure to the data structure corresponding to painting the front bumper. The data processing system can use the large language model to generate or include any number of data structures in the nodal network data structure using any number of queries and/or documents. In doing so, the data processing system can recursively generate structured data to include in the nodal network data structure that can be used to generate a representation of a process for a vehicle repair.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. For example, the data collector 104, large language model 106, nodal network generator 108, agents 110, user interface generator 112, and other data processing system 102 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 1000 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of the user interaction) can be received from the client device at the server (e.g., received by the data processing system 102 from the client device 134 or the remote data source 132).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the data collector 104, large language model 106, nodal network generator 108, agents 110, user interface generator 112, can be a single component, app, or program, or a logic device having one or more processing circuits, or part of one or more servers of the data processing system 102.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A system of real-time synchronization of a nodal network data structure, comprising:
one or more processors to execute instructions stored in memory to:
receive, from a client device, initial vehicle damage data comprising at least damage location information and vehicle identification information of a vehicle;
execute a large language model using the initial vehicle damage data and the vehicle identification information to retrieve first one or more repair records from a retrieval-augmented generation (RAG) database;
generate a nodal network data structure based on the retrieved one or more repair records and the damage location information such that the nodal network data structure comprises a plurality of linked operation nodes representing an ordered sequence of repair operations for repairing vehicle damage of the vehicle damage data and one or more equipment nodes respectively linked to the plurality of linked operation nodes and each indicating equipment for completing the respectively linked operation nodes;
generate, using the large language model, a first visual representation of the nodal network data structure comprising a visual representation of the ordered sequence of repair operations for presentation on a user interface at the client device;
receive additional vehicle damage data corresponding to a first operation node of the linked operation nodes;
execute the large language model using the additional vehicle damage data and the vehicle identification information of the vehicle to retrieve second one or more repair records from the RAG database;
generate a second operation node and an edge between the first operation node and the second operation node based on the second one or more repair records; and
generate, using the large language model, a second visual representation of the nodal network data structure comprising a visual representation of the ordered sequence of repair operations revised based on the generated second operation node and the edge between the first operation node and the second operation node for presentation on a user interface at the client device.

2. The system of claim 1, comprising the one or more processors to:
obtain a plurality of repair records;
segment the plurality of repair records into a plurality of domain-specific chunks each corresponding to a different vehicle part;
generate, using the large language model, an embedding for each of the plurality of domain-specific chunks; and
store each of the plurality of domain-specific chunks in the RAG database with a tag indicating a vehicle part of the domain-specific chunk and the embedding generated for the domain-specific chunk.

3. The system of claim 1, comprising the one or more processors to:
generate a vehicle part tag based on the damage location information of the initial vehicle damage data; and
query, using the large language model, the RAG database using the vehicle part tag.

4. The system of claim 1, comprising the one or more processors to:
obtain a plurality of repair records;
segment the plurality of repair records into a plurality of domain-specific chunks each corresponding to a different vehicle part;
store each of the plurality of domain-specific chunks in the RAG database with a tag indicating a vehicle part associated with the domain-specific chunk; and
retrieve the first one or more repair records based on a tag stored with one or more domain-specific chunks including the first one or more repair records.

5. The system of claim 1, comprising the one or more processors to:
store a plurality of agents, each agent trained to perform a different task; and
generate the nodal network data structure using a first agent of the plurality of agents and a second agent of the plurality of agents, the first agent trained to parse repair records using a natural language processing protocol, and the second agent trained to generate nodes in the nodal network data structure based on language in repair records.

6. The system of claim 1, comprising the one or more processors to:
store a plurality of agents; and
when generating the nodal network data structure:
detect a conflict between a pair of agents of the plurality of agents regarding whether to generate a node within the nodal network data structure; and
responsive to the detection of the conflict, generate an alert to a chat interface of the client device.

7. The system of claim 1, comprising the one or more processors to:
store a plurality of agents; and
when generating the nodal network data structure:
detect a conflict between a pair of agents of the plurality of agents regarding whether to generate a node within the nodal network data structure;
responsive to the detection of the conflict, retrieve, using the large language model, a set of repair records that correspond with the conflict; and
generate the node within the nodal network data structure based on the retrieved set of repair records.

8. The system of claim 1, comprising the one or more processors to:
store a plurality of agents; and
when generating the nodal network data structure:
detect a conflict between a pair of agents of the plurality of agents regarding whether to generate a node within the nodal network data structure;
responsive to detecting the conflict, retrieve, using the large language model, a set of repair records that correspond with the conflict;
generate, using the large language model at a chat interface of the client device, an output requesting input data regarding the vehicle based on the set of repair records;
receive the requested input data from a user; and
generate the node based on the requested input data satisfying a criterion.

9. The system of claim 1, comprising the one or more processors to:
generate the nodal network data structure to include edges between operation nodes indicating an order in which to perform operations to repair the vehicle.

10. The system of claim 1, comprising the one or more processors to:
maintain state information for each operation node indicating a completion status of a corresponding repair operation; and
generate the edge between the first operation node and the second operation node based on a completion status of the first operation node.

11. A method of real-time synchronization of a nodal network data structure, comprising:
receiving, by one or more processors from a client device, initial vehicle damage data comprising at least damage location information and vehicle identification information of a vehicle;
executing, by the one or more processors, a large language model using the initial vehicle damage data and the vehicle identification information to retrieve first one or more repair records from a retrieval-augmented generation (RAG) database;
generating, by the one or more processors, a nodal network data structure based on the retrieved one or more repair records and the damage location information such that the nodal network data structure comprises a plurality of linked operation nodes representing an ordered sequence of repair operations for repairing vehicle damage of the vehicle damage data and one or more equipment nodes respectively linked to the plurality of linked operation nodes and each indicating equipment for completing the respectively linked operation nodes;
generating, by the one or more processors using the large language model, a first visual representation of the nodal network data structure comprising a visual representation of the ordered sequence of repair operations for presentation on a user interface at the client device;
receiving, by the one or more processors, additional vehicle damage data corresponding to a first operation node of the linked operation nodes;
executing, by the one or more processors, the large language model using the additional vehicle damage data and the vehicle identification information of the vehicle to retrieve second one or more repair records from the RAG database;
generating, by the one or more processors, a second operation node and an edge between the first operation node and the second operation node based on the second one or more repair records; and
generating, by the one or more processors using the large language model, a second visual representation of the nodal network data structure comprising a visual representation of the ordered sequence of repair operations revised based on the generated second operation node and the edge between the first operation node and the second operation node for presentation on a user interface at the client device.

12. The method of claim 11, comprising:
obtaining, by the one or more processors, a plurality of repair records;
segmenting, by the one or more processors, the plurality of repair records into a plurality of domain-specific chunks each corresponding to a different vehicle part;
generating, by the one or more processors using the large language model, an embedding for each of the plurality of domain-specific chunks; and
storing, by the one or more processors, each of the plurality of domain-specific chunks in the RAG database with a tag indicating a vehicle part of the domain-specific chunk and the embedding generated for the domain-specific chunk.

13. The method of claim 11, comprising:
generating, by the one or more processors, a vehicle part tag based on the damage location information of the initial vehicle damage data; and
querying, by the one or more processors using the large language model, the RAG database using the vehicle part tag.

14. The method of claim 11, comprising:
obtaining, by the one or more processors, a plurality of repair records;
segmenting, by the one or more processors, the plurality of repair records into a plurality of domain-specific chunks each corresponding to a different vehicle part;
storing, by the one or more processors, each of the plurality of domain-specific chunks in the RAG database with a tag indicating a vehicle part associated with the domain-specific chunk; and
retrieving, by the one or more processors, the first one or more repair records based on a tag stored with one or more domain-specific chunks including the first one or more repair records.

15. The method of claim 11, comprising:
storing, by the one or more processors, a plurality of agents, each agent trained to perform a different task; and
generating, by the one or more processors, the nodal network data structure using a first agent of the plurality of agents and a second agent of the plurality of agents, the first agent trained to parse repair records using a natural language processing protocol, and the second agent trained to generate nodes in the nodal network data structure based on language in repair records.

16. The method of claim 11, comprising:
storing, by the one or more processors, a plurality of agents; and
when generating the nodal network data structure:
detecting, by the one or more processors, a conflict between a pair of agents of the plurality of agents regarding whether to generate a node within the nodal network data structure; and
responsive to the detecting the conflict, generating, by the one or more processors, an alert to a chat interface of the client device.

17. The method of claim 11, comprising:
storing, by the one or more processors, a plurality of agents; and
when generating the nodal network data structure:
detecting, by the one or more processors, a conflict between a pair of agents of the plurality of agents regarding whether to generate a node within the nodal network data structure;
responsive to the detecting the conflict, retrieving, by the one or more processors using the large language model, a set of repair records that correspond with the conflict; and
generating, by the one or more processors, the node within the nodal network data structure based on the retrieved set of repair records.

18. The method of claim 11, comprising:
storing, by the one or more processors, a plurality of agents; and
when generating the nodal network data structure:
detecting, by the one or more processors, a conflict between a pair of agents of the plurality of agents regarding whether to generate a node within the nodal network data structure;
responsive to detecting the conflict, retrieving, by the one or more processors using the large language model, a set of repair records that correspond with the conflict;
generating, by the one or more processors using the large language model at a chat interface of the client device, an output requesting input data regarding the vehicle based on the set of repair records;
receiving, by the one or more processors, the requested input data from a user; and
generating, by the one or more processors, the node based on the requested input data satisfying a criterion.

19. The method of claim 11, comprising:
generating, by the one or more processors, the nodal network data structure to include edges between operation nodes indicating an order in which to perform operations to repair the vehicle.

20. The method of claim 11, comprising:
maintaining, by the one or more processors, state information for each operation node indicating a completion status of a corresponding repair operation; and
generating, by the one or more processors, the edge between the first operation node and the second operation node based on a completion status of the first operation node.
